(19) United States
(12) Patent Application Publication
(10) Pub. No.: US 2026/0369019 A1
(43) Pub. Date: Nov. 19, 2026

(54) TECHNIQUES FOR MANAGING VIRTUAL OBJECTS

(71) Applicant: Apple Inc., Cupertino, CA (US)

(72) Inventors: Hongpeng LIN, Sunnyvale, CA (US); Banafsheh JALALI, San Francisco, CA (US); Christian SCHNORR, Boulder, CO (US)

(21) Appl. No.: 19/354,375

(22) Filed: Oct. 9, 2025

Related U.S. Application Data
(60) Provisional application No. 63/808,546, filed on May 19, 2025.

(51) Int. Cl. G06T 19/20; G06F 3/04815

(52) U.S. Cl. CPC G06T 19/20; G06F 3/04815; G06T 2219/2004; G06T 2219/2016

(57) ABSTRACT

Some techniques are for aligning content based on location of user in accordance with some embodiments. Other techniques are for requesting alignment of content based on user location in accordance with some embodiments. Other techniques are for rendering content in accordance with some embodiments. Other techniques are for requesting content to be rendered in accordance with some embodiments.

### CROSS-REFERENCE TO RELATED APPLICATIONS

The present application claims priority to U.S. Provisional Patent Application Serial No. 63/808,546, entitled “TECHNIQUES FOR MANAGING VIRTUAL OBJECTS,” filed May 19, 2025. The content of these application(s) is hereby incorporated by reference in their entirety.

### BACKGROUND

Managing virtual objects adds complexity for applications. Accordingly, there is a need to ensure that the complexity for applications is reduced.

### SUMMARY

Current techniques for managing virtual objects are generally ineffective and/or inefficient. For example, some techniques require an application to manage and track states of an environment. This disclosure provides more effective and/or efficient techniques for a system process of a head mounted device (HMD) to manage virtual object by allowing the system process to manage and monitor the states of the environment and/or other virtual objects on behalf of an application, thereby reducing application-side complexity for developers. It should be recognized that other types of electronic devices can be used with techniques described herein. For example, a laptop and/or smartphone can manage and track states of an environment using techniques described herein. In addition, techniques optionally complement or replace other techniques for managing virtual objects.

Some techniques are described herein for ensuring a system process renders virtual objects so that some virtual objects remain aligned to a user’s position and other virtual objects change alignment as the user’s position moves within an environment. Other techniques are described here for ensuring that an application is able to perform a user’s requests that require some virtual objects to be aligned to a user’s position and other virtual objects to change alignment with the user as the user’s moves within an environment. Other techniques are described here for ensuring that a system process renders some virtual objects so that they appear to breakthrough another virtual object when the requested virtual objects are covered by the other object. Other techniques are described here for ensuring that an application is able to perform a user’s request that a virtual object breakthrough another virtual objects when the requested virtual object is covered by the other virtual object.

In some embodiments, a method that is performed at a computer system, by a system process, that is in communication with one or more input devices is described. In some embodiments, the method comprises: receiving, from an application, an instruction to align a first object, anchored to a second object, with a subject, wherein the second object is separate from the first object and the subject, and wherein the first object is separate from the subject; after receiving the instruction to align the first object, anchored to the second object, with the subject, detecting, via the one or more input devices, a current location of the subject; after detecting the current location of the subject, rendering: the first object; and the second object based on the current location of the subject; after rendering the first object and the second object, detecting, via the one or more input devices, a change in the current location of the subject; and in response to detecting the change in the current location of the subject, re-rendering, based on the change in the current location of the subject, the second object while maintaining an orientation of the first object with respect to the subject.

In some embodiments, a non-transitory computer-readable storage medium storing one or more programs configured to be executed by one or more processors of a computer system, by a system process, that is in communication with one or more input devices is described. In some embodiments, the one or more programs includes instructions for: receiving, from an application, an instruction to align a first object, anchored to a second object, with a subject, wherein the second object is separate from the first object and the subject, and wherein the first object is separate from the subject; after receiving the instruction to align the first object, anchored to the second object, with the subject, detecting, via the one or more input devices, a current location of the subject; after detecting the current location of the subject, rendering: the first object; and the second object based on the current location of the subject; after rendering the first object and the second object, detecting, via the one or more input devices, a change in the current location of the subject; and in response to detecting the change in the current location of the subject, re-rendering, based on the change in the current location of the subject, the second object while maintaining an orientation of the first object with respect to the subject.

In some embodiments, a transitory computer-readable storage medium storing one or more programs configured to be executed by one or more processors of a computer system, by a system process, that is in communication with one or more input devices is described. In some embodiments, the one or more programs includes instructions for: receiving, from an application, an instruction to align a first object, anchored to a second object, with a subject, wherein the second object is separate from the first object and the subject, and wherein the first object is separate from the subject; after receiving the instruction to align the first object, anchored to the second object, with the subject, detecting, via the one or more input devices, a current location of the subject; after detecting the current location of the subject, rendering: the first object; and the second object based on the current location of the subject; after rendering the first object and the second object, detecting, via the one or more input devices, a change in the current location of the subject; and in response to detecting the change in the current location of the subject, re-rendering, based on the change in the current location of the subject, the second object while maintaining an orientation of the first object with respect to the subject.

In some embodiments, a computer system, by a system process, configured to communicate with one or more input devices is described. In some embodiments, the computer system comprises one or more processors and memory storing one or more programs configured to be executed by the one or more processors. In some embodiments, the one or more programs includes instructions for: receiving, from an application, an instruction to align a first object, anchored to a second object, with a subject, wherein the second object is separate from the first object and the subject, and wherein the first object is separate from the subject; after receiving the instruction to align the first object, anchored to the second object, with the subject, detecting, via the one or more input devices, a current location of the subject; after detecting the current location of the subject, rendering: the first object; and the second object based on the current location of the subject; after rendering the first object and the second object, detecting, via the one or more input devices, a change in the current location of the subject; and in response to detecting the change in the current location of the subject, re-rendering, based on the change in the current location of the subject, the second object while maintaining an orientation of the first object with respect to the subject.

In some embodiments, a computer system, by a system process, configured to communicate with one or more input devices is described. In some embodiments, the computer system comprises means for performing each of the following steps: receiving, from an application, an instruction to align a first object, anchored to a second object, with a subject, wherein the second object is separate from the first object and the subject, and wherein the first object is separate from the subject; after receiving the instruction to align the first object, anchored to the second object, with the subject, detecting, via the one or more input devices, a current location of the subject; after detecting the current location of the subject, rendering: the first object; and the second object based on the current location of the subject; after rendering the first object and the second object, detecting, via the one or more input devices, a change in the current location of the subject; and in response to detecting the change in the current location of the subject, re-rendering, based on the change in the current location of the subject, the second object while maintaining an orientation of the first object with respect to the subject.

In some embodiments, a computer program product is described. In some embodiments, the computer program product comprises one or more programs configured to be executed by one or more processors of a computer system, by a system process, that is in communication with one or more input devices. In some embodiments, the one or more programs include instructions for: receiving, from an application, an instruction to align a first object, anchored to a second object, with a subject, wherein the second object is separate from the first object and the subject, and wherein the first object is separate from the subject; after receiving the instruction to align the first object, anchored to the second object, with the subject, detecting, via the one or more input devices, a current location of the subject; after detecting the current location of the subject, rendering: the first object; and the second object based on the current location of the subject; after rendering the first object and the second object, detecting, via the one or more input devices, a change in the current location of the subject; and in response to detecting the change in the current location of the subject, re-rendering, based on the change in the current location of the subject, the second object while maintaining an orientation of the first object with respect to the subject.

In some embodiments, a method that is performed at a computer system, by an application, that is in communication with one or more input devices and one or more display generation components is described. In some embodiments, the method comprises: detecting, via the one or more input devices, an input corresponding to a request to display content of the application; in response to detecting the input corresponding to the request to display the content of the application, sending, to a system process, a request to render a first object, anchored to a second object to be aligned with a current location of a subject, wherein the second object is separate from the first object and the subject, and wherein the first object is separate from the subject; after sending the request to render the first object, anchored to the second object, to be aligned with the current location of the subject, receiving, from the system process, an indication of an input directed to the content from the subject without the application receiving an indication of the current location of the subject since sending the request; and in response to receiving the indication of the input directed to the content from the subject, resolving the input directed to the content.

In some embodiments, a non-transitory computer-readable storage medium storing one or more programs configured to be executed by one or more processors of a computer system, by an application, that is in communication with one or more input devices and one or more display generation components is described. In some embodiments, the one or more programs includes instructions for: detecting, via the one or more input devices, an input corresponding to a request to display content of the application; in response to detecting the input corresponding to the request to display the content of the application, sending, to a system process, a request to render a first object, anchored to a second object to be aligned with a current location of a subject, wherein the second object is separate from the first object and the subject, and wherein the first object is separate from the subject; after sending the request to render the first object, anchored to the second object, to be aligned with the current location of the subject, receiving, from the system process, an indication of an input directed to the content from the subject without the application receiving an indication of the current location of the subject since sending the request; and in response to receiving the indication of the input directed to the content from the subject, resolving the input directed to the content.

In some embodiments, a transitory computer-readable storage medium storing one or more programs configured to be executed by one or more processors of a computer system, by an application, that is in communication with one or more input devices and one or more display generation components is described. In some embodiments, the one or more programs includes instructions for: detecting, via the one or more input devices, an input corresponding to a request to display content of the application; in response to detecting the input corresponding to the request to display the content of the application, sending, to a system process, a request to render a first object, anchored to a second object to be aligned with a current location of a subject, wherein the second object is separate from the first object and the subject, and wherein the first object is separate from the subject; after sending the request to render the first object, anchored to the second object, to be aligned with the current location of the subject, receiving, from the system process, an indication of an input directed to the content from the subject without the application receiving an indication of the current location of the subject since sending the request; and in response to receiving the indication of the input directed to the content from the subject, resolving the input directed to the content.

In some embodiments, a computer system, by an application, configured to communicate with one or more input devices and one or more display generation components is described. In some embodiments, the computer system comprises one or more processors and memory storing one or more programs configured to be executed by the one or more processors. In some embodiments, the one or more programs includes instructions for: detecting, via the one or more input devices, an input corresponding to a request to display content of the application; in response to detecting the input corresponding to the request to display the content of the application, sending, to a system process, a request to render a first object, anchored to a second object to be aligned with a current location of a subject, wherein the second object is separate from the first object and the subject, and wherein the first object is separate from the subject; after sending the request to render the first object, anchored to the second object, to be aligned with the current location of the subject, receiving, from the system process, an indication of an input directed to the content from the subject without the application receiving an indication of the current location of the subject since sending the request; and in response to receiving the indication of the input directed to the content from the subject, resolving the input directed to the content.

In some embodiments, a computer system, by an application, configured to communicate with one or more input devices and one or more display generation components is described. In some embodiments, the computer system comprises means for performing each of the following steps: detecting, via the one or more input devices, an input corresponding to a request to display content of the application; in response to detecting the input corresponding to the request to display the content of the application, sending, to a system process, a request to render a first object, anchored to a second object to be aligned with a current location of a subject, wherein the second object is separate from the first object and the subject, and wherein the first object is separate from the subject; after sending the request to render the first object, anchored to the second object, to be aligned with the current location of the subject, receiving, from the system process, an indication of an input directed to the content from the subject without the application receiving an indication of the current location of the subject since sending the request; and in response to receiving the indication of the input directed to the content from the subject, resolving the input directed to the content.

In some embodiments, a computer program product is described. In some embodiments, the computer program product comprises one or more programs configured to be executed by one or more processors of a computer system, by an application, that is in communication with one or more input devices and one or more display generation components. In some embodiments, the one or more programs include instructions for: detecting, via the one or more input devices, an input corresponding to a request to display content of the application; in response to detecting the input corresponding to the request to display the content of the application, sending, to a system process, a request to render a first object, anchored to a second object to be aligned with a current location of a subject, wherein the second object is separate from the first object and the subject, and wherein the first object is separate from the subject; after sending the request to render the first object, anchored to the second object, to be aligned with the current location of the subject, receiving, from the system process, an indication of an input directed to the content from the subject without the application receiving an indication of the current location of the subject since sending the request; and in response to receiving the indication of the input directed to the content from the subject, resolving the input directed to the content.

In some embodiments, a method that is performed at a computer system, by a system process, that is in communication with one or more input devices is described. In some embodiments, the method comprises: receiving, from an application, an instruction to display a first object within a user interface; after receiving the instruction to display the first object within the user interface, rendering: the first object; and a second object based on a current location of a subject; after rendering the first object and the second object, detecting, via the one or more input devices, a change in a location corresponding to the user interface; and in response to detecting the change in the location corresponding to the user interface, rendering a first portion of the second object without rendering a second portion of the second object based on the second portion of the second object occluding a portion of the first object, wherein the second portion is different from the first portion.

In some embodiments, a non-transitory computer-readable storage medium storing one or more programs configured to be executed by one or more processors of a computer system, by a system process, that is in communication with one or more input devices is described. In some embodiments, the one or more programs includes instructions for: receiving, from an application, an instruction to display a first object within a user interface; after receiving the instruction to display the first object within the user interface, rendering: the first object; and a second object based on a current location of a subject; after rendering the first object and the second object, detecting, via the one or more input devices, a change in a location corresponding to the user interface; and in response to detecting the change in the location corresponding to the user interface, rendering a first portion of the second object without rendering a second portion of the second object based on the second portion of the second object occluding a portion of the first object, wherein the second portion is different from the first portion.

In some embodiments, a transitory computer-readable storage medium storing one or more programs configured to be executed by one or more processors of a computer system, by a system process, that is in communication with one or more input devices is described. In some embodiments, the one or more programs includes instructions for: receiving, from an application, an instruction to display a first object within a user interface; after receiving the instruction to display the first object within the user interface, rendering: the first object; and a second object based on a current location of a subject; after rendering the first object and the second object, detecting, via the one or more input devices, a change in a location corresponding to the user interface; and in response to detecting the change in the location corresponding to the user interface, rendering a first portion of the second object without rendering a second portion of the second object based on the second portion of the second object occluding a portion of the first object, wherein the second portion is different from the first portion.

In some embodiments, a computer system, by a system process, configured to communicate with one or more input devices is described. In some embodiments, the computer system comprises one or more processors and memory storing one or more programs configured to be executed by the one or more processors. In some embodiments, the one or more programs includes instructions for: receiving, from an application, an instruction to display a first object within a user interface; after receiving the instruction to display the first object within the user interface, rendering: the first object; and a second object based on a current location of a subject; after rendering the first object and the second object, detecting, via the one or more input devices, a change in a location corresponding to the user interface; and in response to detecting the change in the location corresponding to the user interface, rendering a first portion of the second object without rendering a second portion of the second object based on the second portion of the second object occluding a portion of the first object, wherein the second portion is different from the first portion.

In some embodiments, a computer system, by a system process, configured to communicate with one or more input devices is described. In some embodiments, the computer system comprises means for performing each of the following steps: receiving, from an application, an instruction to display a first object within a user interface; after receiving the instruction to display the first object within the user interface, rendering: the first object; and a second object based on a current location of a subject; after rendering the first object and the second object, detecting, via the one or more input devices, a change in a location corresponding to the user interface; and in response to detecting the change in the location corresponding to the user interface, rendering a first portion of the second object without rendering a second portion of the second object based on the second portion of the second object occluding a portion of the first object, wherein the second portion is different from the first portion.

In some embodiments, a computer program product is described. In some embodiments, the computer program product comprises one or more programs configured to be executed by one or more processors of a computer system, by a system process, that is in communication with one or more input devices. In some embodiments, the one or more programs include instructions for: receiving, from an application, an instruction to display a first object within a user interface; after receiving the instruction to display the first object within the user interface, rendering: the first object; and a second object based on a current location of a subject; after rendering the first object and the second object, detecting, via the one or more input devices, a change in a location corresponding to the user interface; and in response to detecting the change in the location corresponding to the user interface, rendering a first portion of the second object without rendering a second portion of the second object based on the second portion of the second object occluding a portion of the first object, wherein the second portion is different from the first portion.

In some embodiments, a method that is performed at a computer system, by an application, that is in communication with one or more input devices and one or more display generation components is described. In some embodiments, the method comprises: while a first object is displayed via the one or more display generation components, detecting, via the one or more input devices, an input corresponding to a request to display a second object, wherein the second object is separate from the first object; and in response to detecting the input corresponding to the request to display the second object, sending, to a system process, a request to configure render of the first object such that a portion of the first object that would occlude a portion of the second object ceases to be displayed, via the one or more display generation components, while the portion of the first object would occlude the portion of the second object.

In some embodiments, a non-transitory computer-readable storage medium storing one or more programs configured to be executed by one or more processors of a computer system, by an application, that is in communication with one or more input devices and one or more display generation components is described. In some embodiments, the one or more programs includes instructions for: while a first object is displayed via the one or more display generation components, detecting, via the one or more input devices, an input corresponding to a request to display a second object, wherein the second object is separate from the first object; and in response to detecting the input corresponding to the request to display the second object, sending, to a system process, a request to configure render of the first object such that a portion of the first object that would occlude a portion of the second object ceases to be displayed, via the one or more display generation components, while the portion of the first object would occlude the portion of the second object.

In some embodiments, a transitory computer-readable storage medium storing one or more programs configured to be executed by one or more processors of a computer system, by an application, that is in communication with one or more input devices and one or more display generation components is described. In some embodiments, the one or more programs includes instructions for: while a first object is displayed via the one or more display generation components, detecting, via the one or more input devices, an input corresponding to a request to display a second object, wherein the second object is separate from the first object; and in response to detecting the input corresponding to the request to display the second object, sending, to a system process, a request to configure render of the first object such that a portion of the first object that would occlude a portion of the second object ceases to be displayed, via the one or more display generation components, while the portion of the first object would occlude the portion of the second object.

In some embodiments, a computer system, by an application, configured to communicate with one or more input devices and one or more display generation components is described. In some embodiments, the computer system comprises one or more processors and memory storing one or more programs configured to be executed by the one or more processors. In some embodiments, the one or more programs includes instructions for: while a first object is displayed via the one or more display generation components, detecting, via the one or more input devices, an input corresponding to a request to display a second object, wherein the second object is separate from the first object; and in response to detecting the input corresponding to the request to display the second object, sending, to a system process, a request to configure render of the first object such that a portion of the first object that would occlude a portion of the second object ceases to be displayed, via the one or more display generation components, while the portion of the first object would occlude the portion of the second object.

In some embodiments, a computer system, by an application, configured to communicate with one or more input devices and one or more display generation components is described. In some embodiments, the computer system comprises means for performing each of the following steps: while a first object is displayed via the one or more display generation components, detecting, via the one or more input devices, an input corresponding to a request to display a second object, wherein the second object is separate from the first object; and in response to detecting the input corresponding to the request to display the second object, sending, to a system process, a request to configure render of the first object such that a portion of the first object that would occlude a portion of the second object ceases to be displayed, via the one or more display generation components, while the portion of the first object would occlude the portion of the second object.

In some embodiments, a computer program product is described. In some embodiments, the computer program product comprises one or more programs configured to be executed by one or more processors of a computer system, by an application, that is in communication with one or more input devices and one or more display generation components. In some embodiments, the one or more programs include instructions for: while a first object is displayed via the one or more display generation components, detecting, via the one or more input devices, an input corresponding to a request to display a second object, wherein the second object is separate from the first object; and in response to detecting the input corresponding to the request to display the second object, sending, to a system process, a request to configure render of the first object such that a portion of the first object that would occlude a portion of the second object ceases to be displayed, via the one or more display generation components, while the portion of the first object would occlude the portion of the second object.

### DESCRIPTION OF THE FIGURES

FIG. 1 illustrates an example system architecture including various electronic devices that may implement the subject system in accordance with some examples.

FIG. 2 illustrates a block diagram of example features of an electronic device in accordance with some examples.

FIG. 3 is a block diagram illustrating a computer system in accordance with some embodiments.

FIGS. 4A-4B illustrate an exemplary process for managing alignment of different virtual objects in accordance with some embodiments.

FIG. 5 is a flow diagram illustrating a process for aligning content based on location of user in accordance with some embodiments.

FIG. 6 is a flow diagram illustrating a process for requesting alignment of content based on user location in accordance with some embodiments.

FIGS. 7A-7F illustrate an exemplary process for managing an overlay within an environment in accordance with some embodiments.

FIG. 8 is a flow diagram illustrating a process for rendering content in accordance with some embodiments.

FIG. 9 is a flow diagram illustrating a process for requesting content to be rendered in accordance with some embodiments.

FIGS. 10A-10G illustrate an electronic system with which some examples of the subject technology may be implemented in accordance with some examples.

### DETAILED DESCRIPTION

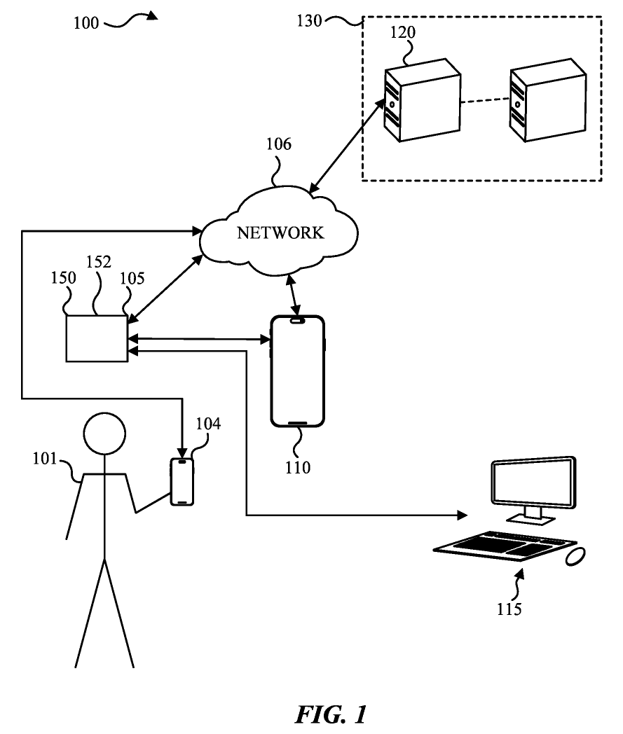

FIG. 1 illustrates an example system architecture 100 including various electronic devices that may implement the subject system in accordance with some embodiments. Not all of the depicted components may be used in all embodiments, however, and some embodiments may include additional or different components than those shown in the figure. Variations in the arrangement and type of the components may be made without departing from the spirit or scope of the claims as set forth herein. Additional components, different components, or fewer components may be provided.

The system architecture 100 includes an electronic device 105, a handheld electronic device 104, an electronic device 110, an electronic device 115, and a server 120. For explanatory purposes, the system architecture 100 is illustrated in FIG. 1 as including the electronic device 105, the handheld electronic device 104, the electronic device 110, the electronic device 115, and the server 120; however, the system architecture 100 may include any number of electronic devices, and any number of servers or a data center including multiple servers.

The electronic device 105 may be implemented, for example, as a tablet device, a smartphone, or as a head mountable portable system (e.g., worn by a user 101). The electronic device 105 includes a display system capable of presenting a visualization of an extended reality environment to the user. The electronic device 105 may be powered with a battery and/or another power supply. In an example, the display system of the electronic device 105 provides a stereoscopic presentation of the extended reality environment, enabling a three-dimensional visual display of a rendering of a particular scene, to the user. In some embodiments, instead of, or in addition to, utilizing the electronic device 105 to access an extended reality environment, the user may use a handheld electronic device 104, such as a tablet, watch, mobile device, and the like.

The electronic device 105 may include one or more cameras such as camera(s) 150 (e.g., visible light cameras, infrared cameras, etc.) For example, the electronic device 105 may include multiple cameras 150. For example, the multiple cameras 150 may include a left facing camera, a front facing camera, a right facing camera, a down facing camera, a left-down facing camera, a right-down facing camera, an up facing camera, one or more eye-facing cameras, and/or other cameras. Each of the cameras 150 may include one or more image sensors (e.g., charged coupled device (CCD) image sensors, complementary metal oxide semiconductor (CMOS) image sensors, or the like).

Further, the electronic device 105 may include various sensors 152 including, but not limited to, other cameras, other image sensors, touch sensors, microphones, inertial measurement units (IMU), heart rate sensors, temperature sensors, depth sensors (e.g., Lidar sensors, radar sensors, sonar sensors, time-of-flight sensors, etc.), GPS sensors, Wi-Fi sensors, near-field communications sensors, radio frequency sensors, etc. Moreover, the electronic device 105 may include hardware elements that can receive user input such as hardware buttons or switches. User inputs detected by such cameras, sensors, and/or hardware elements may correspond to, for example, various input modalities. For example, such input modalities may include, but are not limited to, facial tracking, eye tracking (e.g., gaze direction), hand tracking, gesture tracking, biometric readings (e.g., heart rate, pulse, pupil dilation, breath, temperature, electroencephalogram, olfactory), recognizing speech or audio (e.g., particular hotwords), and activating buttons or switches, etc. In some embodiments, facial tracking, gaze tracking, hand tracking, gesture tracking, object tracking, and/or physical environment mapping processes (e.g., system processes and/or application processes) may utilize images (e.g., image frames) captured by one or more image sensors of the cameras 150 and/or the sensors 152.

In some embodiments, the electronic device 105 may be communicatively coupled to a base device such as the electronic device 110 and/or the electronic device 115. Such a base device may, in general, include more computing resources and/or available power in comparison with the electronic device 105. In an example, the electronic device 105 may operate in various modes. For instance, the electronic device 105 can operate in a standalone mode independent of any base device. When the electronic device 105 operates in the standalone mode, the number of input modalities may be constrained by power and/or processing limitations of the electronic device 105 such as available battery power of the device. In response to power limitations, the electronic device 105 may deactivate certain sensors within the device itself to preserve battery power and/or to free processing resources.

The electronic device 105 may also operate in a wireless tethered mode (e.g., connected via a wireless connection with a base device), working in conjunction with a given base device. The electronic device 105 may also work in a connected mode where the electronic device 105 is physically connected to a base device (e.g., via a cable or some other physical connector) and may utilize power resources provided by the base device (e.g., where the base device is charging the electronic device 105 and/or providing power to the electronic device 105 while physically connected).

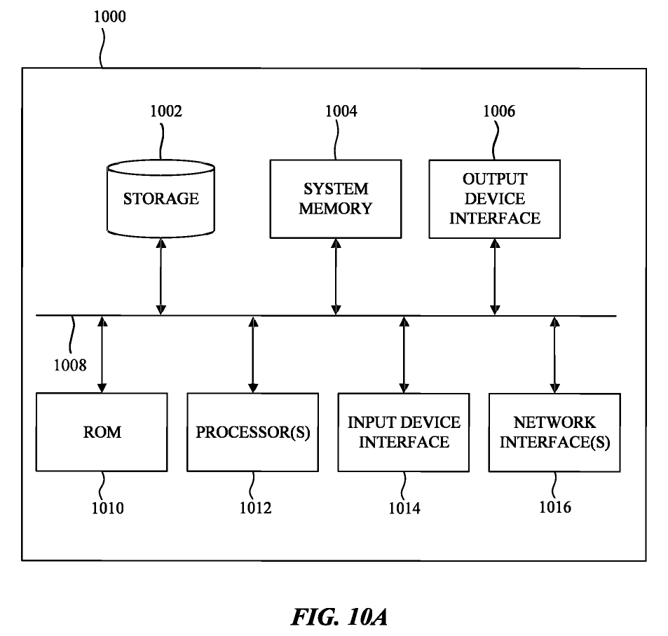

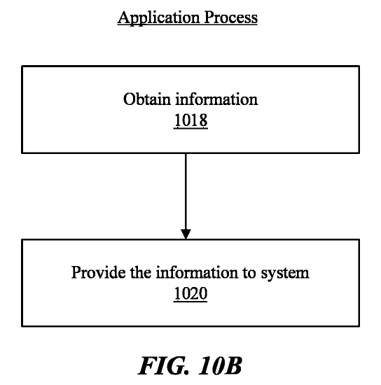

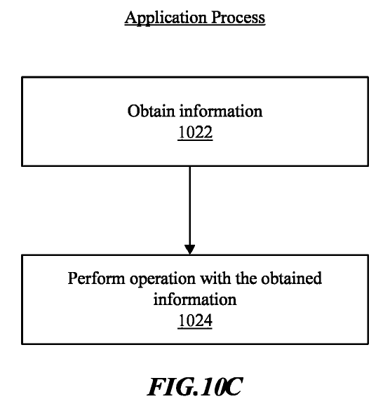

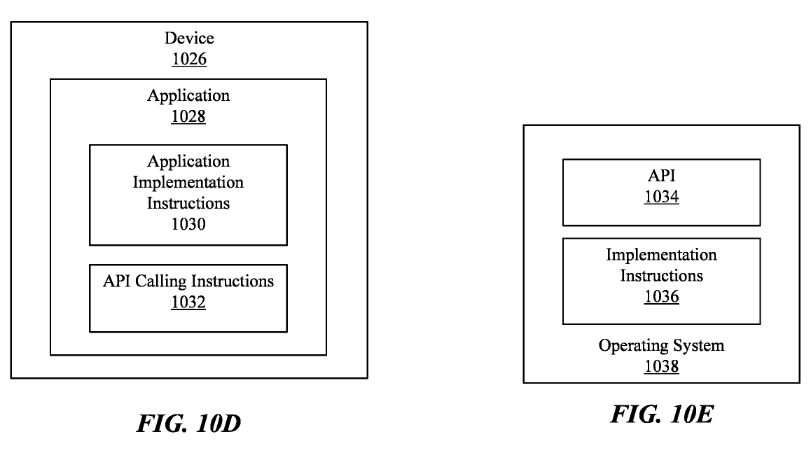

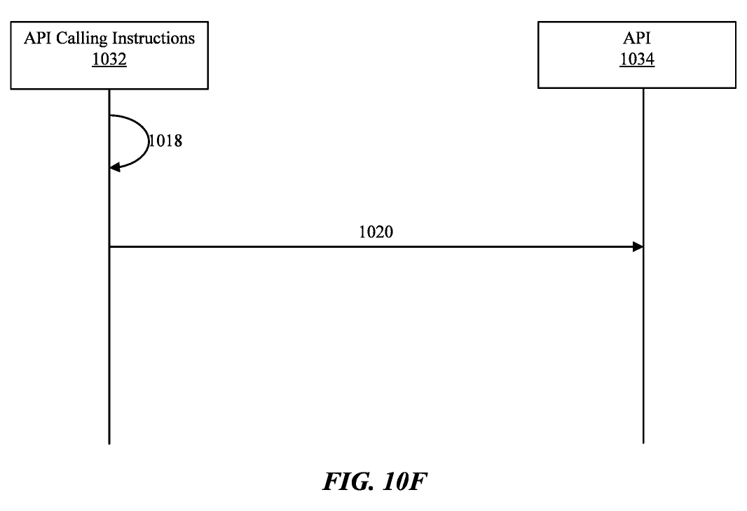

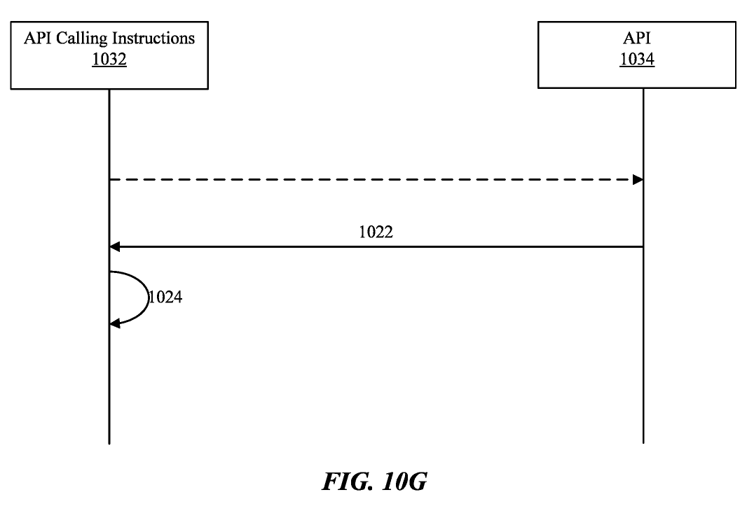

When the electronic device 105 operates in the wireless tethered mode or the connected mode, a least a portion of processing user inputs and/or rendering the extended reality environment may be offloaded to the base device thereby reducing processing burdens on the electronic device 105. For instance, in an example, the electronic device 105 works in conjunction with the electronic device 110 or the electronic device 115 to generate an extended reality environment including physical and/or virtual objects that enables different forms of interaction (e.g., visual, auditory, and/or physical or tactile interaction) between the user and the generated extended reality environment in a real-time manner. In an example, the electronic device 105 provides a rendering of a scene corresponding to the extended reality environment that can be perceived by the user and interacted with in a real-time manner, such as a host environment for a group session with another user. Additionally, as part of presenting the rendered scene, the electronic device 105 may provide sound, and/or haptic or tactile feedback to the user. The content of a given rendered scene may be dependent on available processing capability, network availability and capacity, available battery power, and current system workload. The electronic device 105 may be, and/or may include all or part of, the electronic system discussed below with respect to FIG. 10A.

The network 106 may communicatively (directly or indirectly) couple, for example, the electronic device 105, the electronic device 110, and/or the electronic device 115 with each other device and/or the server 120. In some embodiments, the network 106 may be an interconnected network of devices that may include, or may be communicatively coupled to, the Internet.

The handheld electronic device 104 may be, for example, a smartphone, a portable computing device such as a laptop computer, a companion device (e.g., a digital camera, headphones), a tablet device, a wearable device such as a watch, a band, and the like, or any other appropriate device that includes, for example, one or more speakers, communications circuitry, processing circuitry, memory, a touchscreen, and/or a touchpad. In some embodiments, the handheld electronic device 104 may not include a touchscreen but may support touchscreen-like gestures, such as in an extended reality environment. In some embodiments, the handheld electronic device 104 may include a touchpad. In FIG. 1, by way of example, the handheld electronic device 104 is depicted as a tablet device.

The electronic device 110 may be, for example, a smartphone, a portable computing device such as a laptop computer, a companion device (e.g., a digital camera, headphones), a tablet device, a wearable device such as a watch, a band, and the like, or any other appropriate device that includes, for example, one or more speakers, communications circuitry, processing circuitry, memory, a touchscreen, and/or a touchpad. In some embodiments, the electronic device 110 may not include a touchscreen but may support touchscreen-like gestures, such as in an extended reality environment. In some embodiments, the electronic device 110 may include a touchpad. In FIG. 1, by way of example, the electronic device 110 is depicted as a tablet device. In some embodiments, the electronic device 110, the handheld electronic device 104, and/or the electronic device 105 may be, and/or may include all or part of, the electronic system discussed below with respect to FIG. 10A. In some embodiments, the electronic device 110 may be another device such as an Internet Protocol (IP) camera, a tablet, or a companion device such as an electronic stylus, etc.

The electronic device 115 may be, for example, desktop computer, a portable computing device such as a laptop computer, a smartphone, a companion device (e.g., a digital camera, headphones), a tablet device, a wearable device such as a watch, a band, and the like. In FIG. 1, by way of example, the electronic device 115 is depicted as a desktop computer having one or more cameras 150 (e.g., multiple cameras 150). The electronic device 115 may be, and/or may include all or part of, the electronic system discussed below with respect to FIG. 10A.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files for extended reality environments. In an example, the server 120 may function as a cloud storage server that stores any of the aforementioned extended reality content generated by the above-discussed devices and/or the server 120.

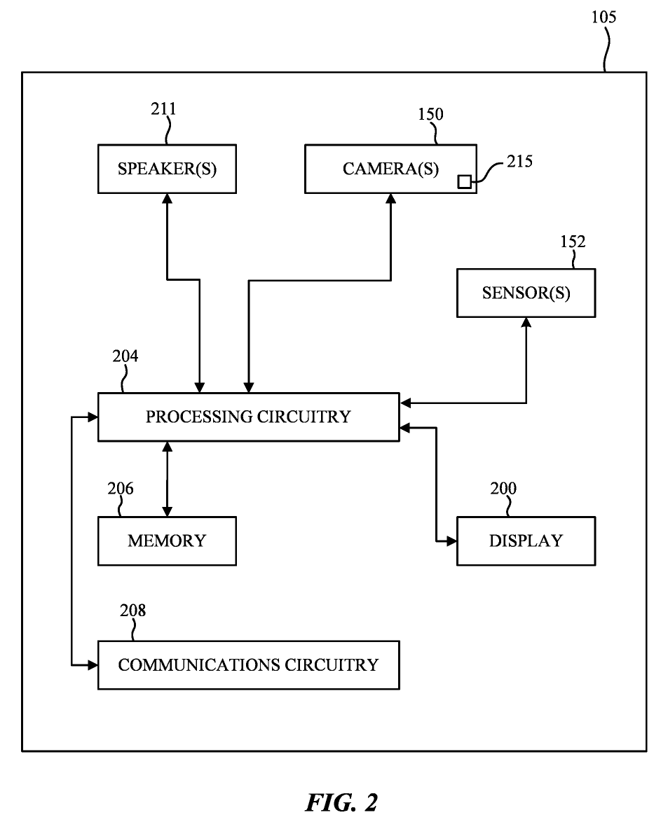

FIG. 2 illustrates a block diagram of various components that may be included in electronic device 105, in accordance with aspects of the disclosure. As shown in FIG. 2, electronic device 105 may include one or more cameras such as camera(s) 150 (e.g., multiple cameras 150, each including one or more image sensors 215) that capture images and/or video of the physical environment around the electronic device, one or more sensors 152 that obtain environment information (e.g., depth information) associated with the physical environment around the electronic device 105. Sensors 152 may include depth sensors (e.g., time-of-flight sensors, infrared sensors, radar, sonar, lidar, etc.), one or more microphones, and/or other types of sensors for sensing the physical environment. For example, one or more microphones included in the sensor(s) 152 may be operable to capture audio input from a user of the electronic device 105, such as a voice input corresponding to the user speaking into the microphones. In the example of FIG. 2, electronic device 105 also includes communications circuitry 208 for communication with electronic device 110, electronic device 115, servers 120, and/or other devices and/or systems in some embodiments. Communications circuitry 208 may include radio frequency (RF) communications circuitry for detecting radio frequency identification (RFID) tags, Bluetooth Low Energy (BLE) communications circuitry, other near-field communications (NFC) circuitry, Wi-Fi communications circuitry, cellular communications circuitry, and/or other wired and/or wireless communications circuitry.

As shown, electronic device 105 includes processing circuitry 204 (e.g., one or more processors and/or integrated circuits) and memory 206. Memory 206 may store (e.g., temporarily or permanently) content generated by and/or otherwise obtained by electronic device 105. In some operational scenarios, memory 206 may temporarily store images of a physical environment captured by camera(s) 150, depth information corresponding to the images generated, for example, using a depth sensor of sensors 152, meshes and/or textures corresponding to the physical environment, virtual objects such as virtual objects generated by processing circuitry 204 to include virtual content, and/or virtual depth information for the virtual objects. Memory 206 may store (e.g., temporarily or permanently) intermediate images and/or information generated by processing circuitry 204 for combining the image(s) of the physical environment and the virtual objects and/or virtual image(s) to form, e.g., composite images for display by display 200, such as by compositing one or more virtual objects onto a pass-through video stream obtained from one or more of the cameras 150.

As shown, the electronic device 105 may include one or more speakers 211. The speakers may be operable to output audio content, including audio content stored and/or generated at the electronic device 105, and/or audio content received from a remote device or server via the communications circuitry 208.

Memory 206 may store instructions or code for execution by processing circuitry 204, such as, for example operating system code corresponding to an operating system installed on the electronic device 105, and application code corresponding to one or more applications installed on the electronic device 105. The operating system code and/or the application code, when executed, may correspond to one or more operating system level processes and/or application level processes, such as processes that support capture of images, obtaining and/or processing environmental condition information, and/or determination of inputs to the electronic device 105 and/or outputs (e.g., display content on display 200) from the electronic device 105.

In some embodiments, one or more input devices include one or more camera sensors (e.g., one or more optical sensors and/or one or more depth camera sensors such as for tracking a user’s gestures (e.g., hand gestures and/or air gestures) as input). In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user’s body through the air including motion of the user’s body relative to an absolute reference (e.g., an angle of the user’s arm relative to the ground or a distance of the user’s hand relative to the ground), relative to another portion of the user’s body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user’s body (e.g., a tap gesture that includes movement of a hand in a predetermined pose by a predetermined amount and/or speed, or a shake gesture that includes a predetermined speed or amount of rotation of a portion of the user’s body).

Attention is now directed towards techniques for managing computer-generated environments. Such techniques are described in the context of an application requesting that user interface elements be managed by a system process, including (1) alignment of the user interface elements with respect to other user interface elements and a subject detected in the computer-generated environment and (2) display priority between different user interface elements. It should be recognized that other configurations can be used with techniques described herein. In addition, techniques optionally complement or replace other techniques for managing computer-generated environments.

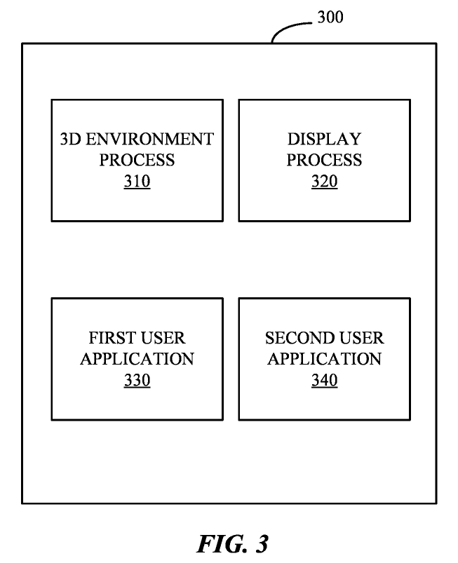

FIG. 3 is a block diagram illustrating a computer system in accordance with some embodiments. While described below as a head-mounted display (HMD) device, it should be recognized that computer system 300 can be other types of devices, such as a phone, a watch, a tablet, a fitness tracking device, a processor, a communal device, a media device, a speaker, a television, an electronic device, a camera, and/or a personal computing device. In some embodiments, computer system 300 includes one or more components described above with respect to electronic device 105, handheld electronic device 104, electronic device 110, electronic device 115, and/or server 120. Variations in the arrangement and type of the components can be made without departing from the spirit or scope of the claims as set forth herein. Additional, different, and/or fewer components can be used as well.

In some embodiments, computer system 300 loads, renders, manages, and/or displays computer-generated content in a 3D environment. The 3D environment can be virtual and/or physical, with the computer-generated content either completely covering or supplementing a field-of-view that includes a physical environment. For example, the 3D environment can include computer generated content that appears to be floating in the physical environment. In some embodiments, computer system 300 causes a virtual environment to be rendered and displayed to a user such that the user is provided content that is reactive to movements and/or gestures of the user. In response to detecting such actions, computer system 300 processes the actions to provide tailored information to applications executing on computer system 300.

As illustrated in FIG. 3, computer system 300 includes 3D environment process 310, display process 320, first user application 330, and second user application 340. While FIG. 3 illustrates that each of these components are on a single computer system, it should be recognized that one or more components can be on another computer system in communication (e.g., wired and/or wireless communication) with computer system 300. In addition, while each component will be discussed separately, in some embodiments, the functionality of one or more components are combined together or separated further. In some embodiments, one or more components of computer system 300 communicate with other components via application programming interfaces (APIs), inter-process communications (IPCs), and/or serial peripheral interfaces (SPIs).

In some embodiments, 3D environment process 310 executes as a background process (e.g., a daemon, a service, a system process, an application process, and/or one or more instructions) to manage the 3D environment on behalf of one or more applications (e.g., first user application 350 and/or second user application 360). For example, 3D environment process 310 can create the 3D environment, manage a state of the 3D environment, receive requests from the one or more applications to render content in the 3D environment, cause display process 320 to display the 3D environment, and/or detect and process inputs from a number of different sources. In some embodiments, 3D environment process 310 receives 3D object models from first user application 330 and/or second user application 340 and renders them based on a current state of the 3D environment and/or a user’s position. In some embodiments, the user’s position is obtained and/or determined through sensors , such as optical sensors, GPS sensors, Wi-Fi positioned sensors, cellular network sensors, Bluetooth beacons, and/or inertial sensors (e.g., accelerometers, gyroscopes, and/or magnetometers).

In some embodiments, 3D environment process 310 provides one or more APIs to be used by the one or more applications for setting up the 3D environment. In such embodiments, the APIs can work in a declarative form that allow for developers to create views, animations, and/or other user-interface elements without needing to configure the 3D environment imperatively. In some embodiments, 3D environment process 310 creates a scene via a scene graph, adds one or more entities to the scene, and/or causes the scene to be rendered.

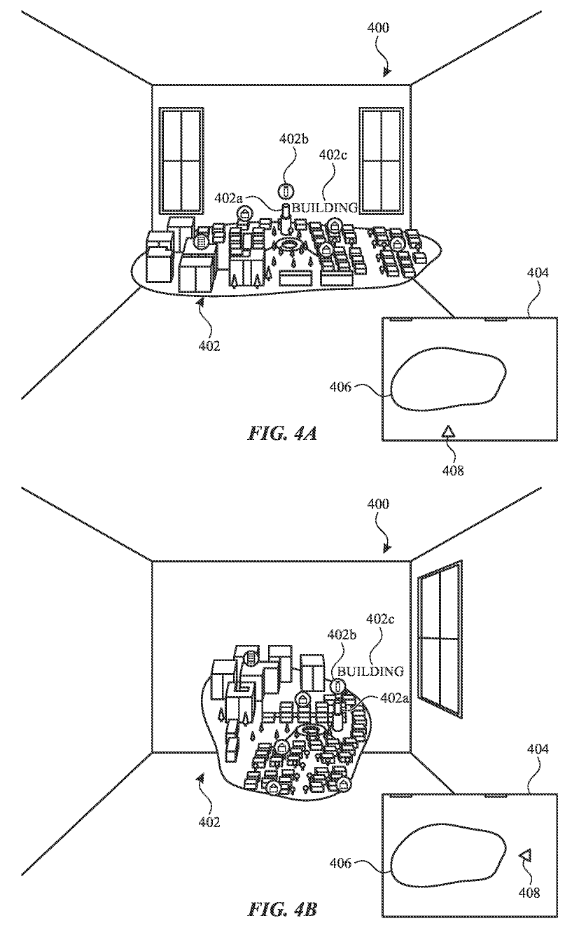

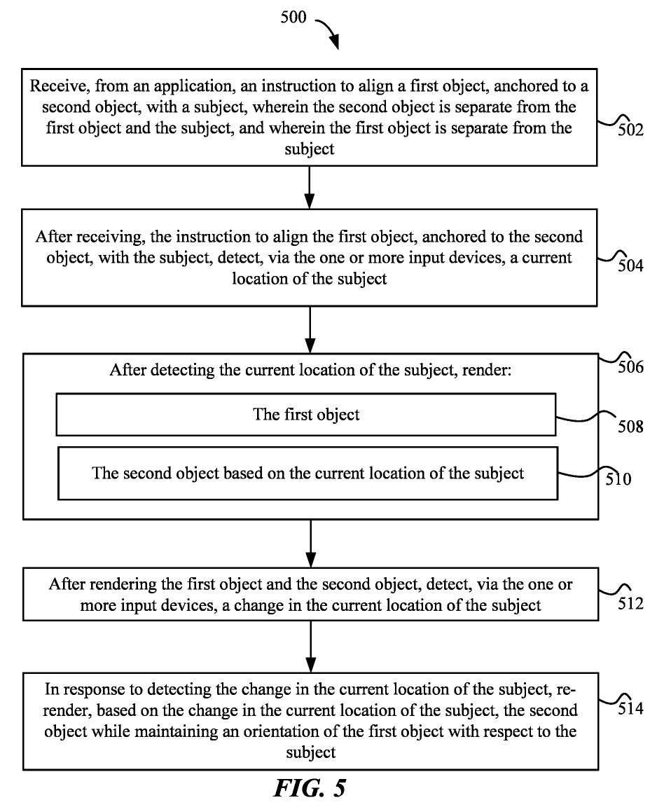

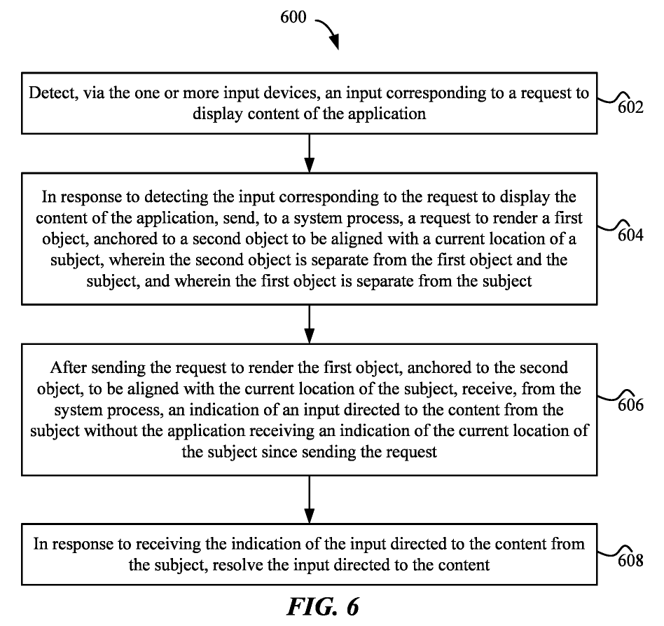

FIGS. 4A-4B illustrate an exemplary process for managing alignment of different virtual objects in accordance with some embodiments. The exemplary process is used to illustrate the processes described below, including the processes in FIGS. 5-6.

As mentioned above with respect to FIG. 3, 3D environment process 310 can receive 3D object models from first user application 330 and render the 3D object models based on a current state of an environment (e.g., environment 400) and/or a user’s position to produce a 3D object to be displayed by display process 320. In some embodiments, 3D environment process 310 updates an appearance of the 3D object using the 3D object model as the 3D object moves and/or a user moves without requiring communication with first user application 330. Thus limiting an amount of information, such as position, location, and/or orientation information, shared with first user application 330 while still being able to provide a responsive 3D experience. In some embodiments, some virtual objects rendered by 3D environment process 310 change in appearance based on a user’s position. For example, when the user is viewing a virtual object such as a building, the user’s viewpoint of the building changes as the user walks around the building. This allows the user to feel as if the building is physically present. In some embodiments, other virtual objects are rendered by 3D environment process 310 so that some characteristics of the virtual object are static and do not change based on the user’s position and/or another virtual object’s position. For example, when the user is viewing an informational overlay with text associated with another virtual object such as a building, it is advantageous for the user to have the text of the information overlay always be aligned to the user’s viewpoint and for the informational overlay to be anchored to the building, allowing the user to be in view of the virtual object (e.g., the building) and the text from the corresponding informational overlay despite the user changing location. The ability for the 3D environment process 310 to render virtual objects in this manner can allow for a better experience for the user. In some embodiments, virtual objects like the information overlay are rendered by 3D environment process 310 in a quantized manner. For example, 3D environment process 310 updates an orientation of the information overlay when the user’s position (and/or viewpoint) changes by a defined interval such as 45 or 90 degrees. This quantized approach can reduce processing overhead and/or provide a more stable visual experience.

FIGS. 4A-4B illustrates environment 400 with virtual map 402 including multiple virtual objects (e.g., building 402a, image overlay 402b, and text overlay 402c). In some embodiments, environment 400 is a physical and/or virtual environment. For example, environment 400 can be a representation of a physical environment captured by one or more cameras of computer system 300. For another example, environment 400 can be a physical environment viewed through one or more at least partially translucent materials. It should be understood that environment 400 can be seen through a display or a display area of a computer system, such as an HMD device and/or smart glasses. In some embodiments, the display area is a display generation component, such as a translucent display and/or a display screen. In some embodiments, environment 400 is a completely virtual environment that is rendered by computer system 300. In some embodiments, virtual objects are displayed within and/or in a manner to appear as if they are within environment 400.

The bottom-right side of FIGS. 4A-4B includes diagram 404. Diagram 404 is a visual aid representing locations of objects within environment 400. Diagram 404 includes user representation 408 and virtual map representation 406 to indicate a position and/or orientation of both objects within environment 400. Diagram 404 also illustrates a position of the user relative to virtual map 402. It should be understood that 3D and 2D objects are used as examples and that other virtual objects can be used with techniques described herein, including a geometrical figure, a character, a symbol, a representation of an inanimate object, and/or a representation of an animate object.

At FIG. 4A, the user is positioned so that the user is facing a backwall (e.g., the backwall is a wall with windows) of environment 400. Prior to displaying the 3D objects, the user launches a map application and requests the map application to display a 3D map of a city. In response to the user’s request, 3D environment process 310 receives one or more 3D models corresponding to virtual objects from the map application. For example, the map application sends a 3D model for each building and some information overlays (e.g., image overlay 402b) illustrated in FIG. 4A. In some embodiments, a single 3D model is sent which accounts for each building and informational overlay illustrated in FIG. 4A. As described earlier, 3D environment process 310 is provided positional information about the user’s position from sensors in communication with computer system 300. In some embodiments, the positional information of the user is not provided to the map application. After receiving the 3D models, 3D environment process 310 causes display process 320 to display the virtual objects based on environment 400 and/or the user’s position.

As illustrated in FIG. 4A, virtual map 402 includes multiple 3D objects, such as building 402a, image overlay 402b, and text overlay 402c. At FIG. 4A, image overlay 402b and text overlay 404c are anchored to building 402a, so that image overlay 402b and text overlay 404c are spatially bound to building 402a. That is, even if the user’s position changes, building 402a, image overlay 402b, and text overlay 402c are to always be within a predetermined distance and/or orientation of each other. As illustrated in FIG. 4A, text overlay 404c is a 2D object. In some embodiments, text overlay 404 is a 3D object.

In some embodiments, virtual object 402a is a parent object of text overlay 402c and image overlay 402b. In such embodiments, text overlay 402cand image overlay 402b can inherit one or more attributes of virtual object 402a. For example, text overlay 402c and/or image overlay 402b can inherit some spatial characteristics from virtual object 402a, such as scaling properties and/or orientation alignment values. Such spatial properties and/or orientation alignment values can be explicitly defined within virtual object 402a and can be implicitly defined (e.g., a pointer to virtual object 402a) in text overlay 402cand/or image overlay 402b. In some embodiments, text overlay 402cand/or image overlay 402b inherits a visual appearance of virtual object 402a, such as lighting, color, and/or surface texture. In some embodiments, text overlay 402cand/or image overlay 402b inherits an interactive behavior of virtual object 402a, such as an animation trigger and/or am input response to touch or gaze. In some embodiments, the map application uses an API that enables a child object to inherit one or more attributes and/or behaviors from an associated parent object.

As illustrated in FIG. 4A, virtual map 402 is rendered with a first viewing angle so that all the buildings, trees, and other landmarks are presented to the user as if the user is viewing the building from a first direction (e.g., viewing the buildings from the east side of the city). At some time between FIGS. 4A and 4B, the user moves from the position illustrated in FIG. 4A to the position illustrated in FIG. 4B. One or more sensors, such as a camera, that are in communication with computer system 300 captures the user’s change in position. 3D environment process 310 is notified of the user’s change in position. In response to the notification 3D environment process 310 renders (and/or re-renders) virtual map 402 so that the user is presented with a second viewing angle of virtual map 402 (e.g., viewing the building from the south side of the city). In some embodiments, 3D environment process 310 re-renders only virtual objects that are changed due to the user’s movement.

As illustrated in FIG. 4B, image overlay 402b and text overlay 404c are presented to the user in the same way as FIG. 4A, even though the user’s position changed. 3D environment process 310 aligns image overlay 402b and text overlay 404c with the user regardless of the user’s current viewing direction. In some embodiments, image overlay 402band text overlay 404c are not re-rendered since the overlays are presented in the same manner. In some embodiments, image overlay 402b and text overlay 404c are not configured to always be aligned to the user’s position. Instead as the user moves within environment 400, 3D environment process 310 renders different perspectives of the overlays based on the user’s position. In some embodiments, virtual map 402 includes a control interface such as a grabber user interface element that is positioned adjacent to virtual map 402. In such embodiments, the grabber user interface can be used by a user to re-orient virtual map 402. In some embodiments, a user can re-orient the overlays to the user’s position by providing a designated input such as gazing at and/or gesturing toward (e.g., tapping on and/or in the direction of) the overlay that the user wants aligned to the user’s position.

As illustrated in FIG. 4B, virtual object 402a is presented from the second viewing angle and is re-rendered by 3D environment process 310. In order to present virtual object 402a with the second viewing angle, 3D environment process 310 uses a primary axis of virtual object 402a as defined by the map application. The primary axis designates the main direction in which the virtual object is to be rendered. For example, the map application can specify that z-axis of the virtual object 402a is the primary axis. As such, 3D environment process 310 uses the z-axis of object of 402a when it orients virtual object 402a to face the viewpoint and/or location of the user.

Likewise, the map application can specify that the text of text overlay 404c faces the position of the user. In some embodiments, the map application can specify that virtual objects should be aligned with the user with a primary and a secondary axis of the virtual object. In such embodiments, the virtual object is aligned with the user along two axis such as z-axis and y-axis.

In some embodiments, 3D environment process 310 re-renders virtual objects without receiving any new instructions from the map application and instead re-renders based on a change in position of the user. This configuration can enable 3D environment process 310 to independently handle re-rendering of virtual objects without having to continuously communicate with the map application to receive rendering instructions. In some embodiments, 3D environment process 310 re-renders virtual objects based on detecting an input from the user, such as voice command and/or tap that directs 3D environment process 310 to re-render virtual objects.

In some embodiments, re-rendering of objects by 3D environment process 310 is constrained by angular limits set by the map application. For example, when the user’s position changes relative to an already rendered virtual object, 3D environment process 310 uses a maximum and/or a minimum rotation angle defined by the map application 3D when re-rendering the virtual object relative to the user’s new position. This can prevent virtual objects from being rotated beyond a specified rotation angle the map application has defined.

In some embodiments, certain virtual objects like buildings are anchored to a particular position in the virtual environment and re-rendered at that particular (and/or fixed) position. For example, the map application can cause display of virtual objects such as buildings that stay in the same position even as the user moves around the buildings. In some embodiments, other virtual objects like overlays are not anchored to a particular position but bound to other virtual objects. As such, these non-anchored virtual objects are re-rendered relative to the virtual object to which they are bound and not a particular location. This can allow 3D environment process 310 to render the overlay within a proximity of a corresponding virtual object, so that the user can quickly view information related to the virtual object.

In some embodiments, the map application uses an API that enables one text overlay to react to another text overlay’s status. For example, when a first text overlay is dismissed by the user, a second text overlay can automatically update its appearance in response. This update happens without the map application needing to check the current state of the environment. Instead, the API manages the communication between the overlays, reducing the need for the map application to continual communicate with 3D environment process 310.

In some embodiments, the map application uses an API that enables the scale of an overlay to change based on a distance from a camera of computer system 300. For example, if the user is viewing a virtual street sign and moves away from the street sign, the sign will gradually appear to shrink in size to reflect the user’s distance. Similarly, as the user moves toward the sign, the virtual sign would appear to get larger. In some embodiments, the API limits a maximum and minimize amount an overlay can change based on the user’s position. For example, once the user gets within a predetermined distance an overlay, 3D environmental process will stop enlarging the overlay. Similarly, once the user a predetermined distance away from the over, 3D environment process 310 will stop reducing the size of the overlay. In some embodiments, the size of virtual objects like text overlays are also constrained by limits set by the map application. For example, 3D environment process 310 uses a maximum and a minimum virtual object size defined by the map application when re-rendering the text overlay relative to a user’s changed position. The maximum virtual object size can prevent the text overlay from bumping into or overlapping another text overlay. The minimum virtual object size can prevent the text overlay from becoming illegible. In some embodiments, text sizes of overlay objects are constrained by limits set by the map application. For example, when the user’s position changes relative to an already rendered text overlay, 3D environment process 310 uses a maximum and a minimum text size defined by the map application when re-rendering the text overlay relative to the user’s changed position. The maximum and minimum text size can ensure that text in the overlay are legible.

FIG. 5 is a flow diagram illustrating a process (e.g., process 500) for aligning content based on location of user in accordance with some embodiments. Some operations in process 500 are, optionally, combined, the orders of some operations are, optionally, changed, and some operations are, optionally, omitted.

As described below, process 500 provides an intuitive way for aligning content based on location of user in accordance with some embodiments. Process 500 reduces the cognitive burden on a user, thereby creating a more efficient human-machine interface. For battery-operated computing devices, enabling a user to interact with such devices faster and more efficiently conserves power and increases the time between battery charges.

In some embodiments, process 500 is performed at a computer system (e.g., 300), by a system process (e.g., 310), that is in communication with (and/or includes) one or more input devices (e.g., as described above with respect to FIG. 3) (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, the computer system is a head-mounted display (HMD) device, a communal device, a watch, a phone, a tablet, a fitness tracking device, a processor, a media device, a speaker, a television, an electronic device, and/or a personal computing device. In some embodiments, the system process is part of and/or executing on behalf of an operating system of the computer system.

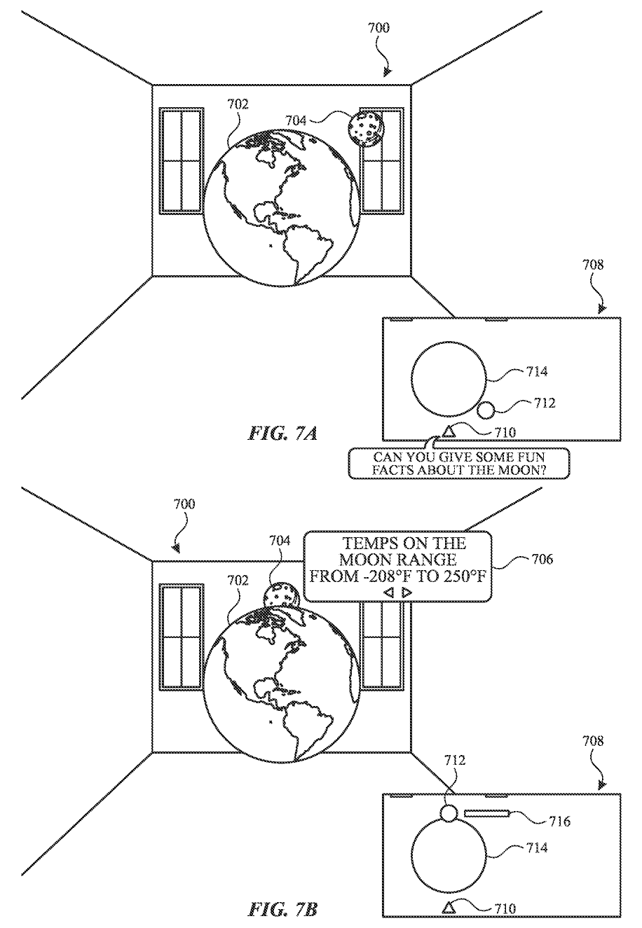

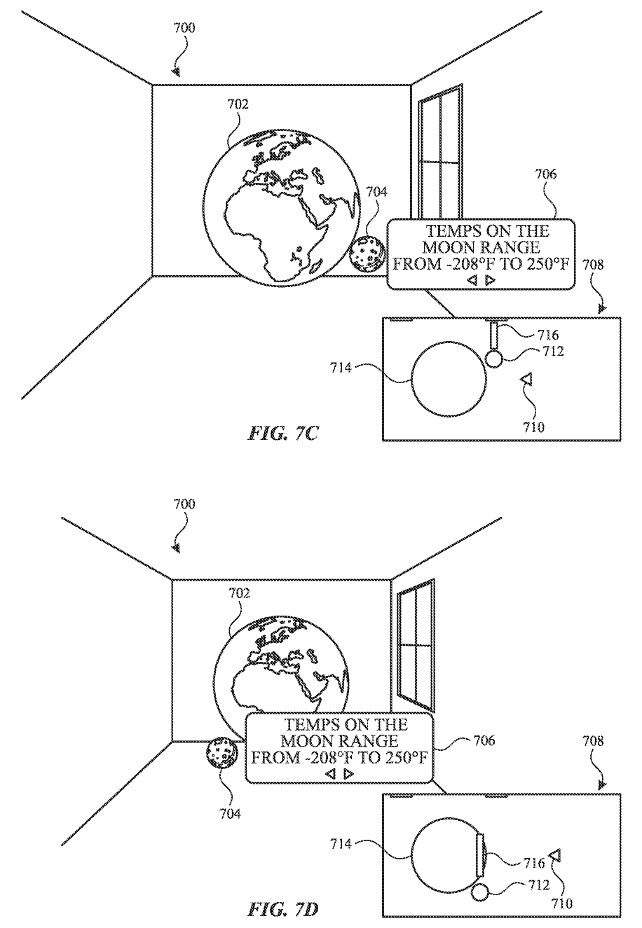

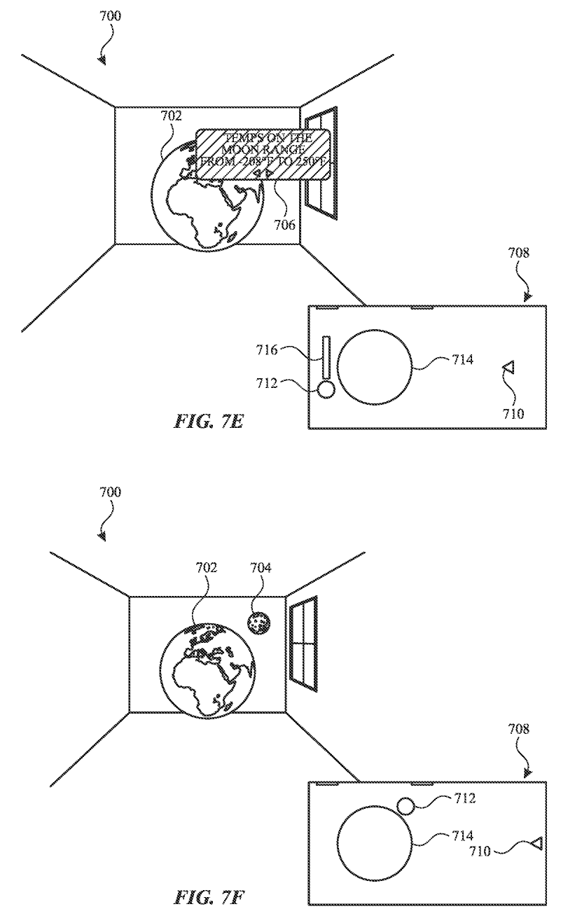

The system process receives (502), from an application (e.g., 330 and/or 340) (e.g., a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application), an instruction (e.g., an API request, an operation request, an execution instruction, a function call, a command, and/or a request) to align (e.g., orient, intersect coordinates with, geometrically align, face, and/or share the same axis as) a first object (e.g., 402b, 402c, and/or 706) (e.g., a popup, a menu, a virtual button, an icon, a widget, a control, a window, 3D object, and/or 2D object), anchored to (e.g., parent of, child of, grandparent of, grandchild of, attached to, spatially bound to, positionally liked to, synchronized with, tracked with, follows, related to, and/or co-located with) a second object (e.g., 402a and/or 704) (e.g., content, a virtual button, an icon, a widget, a control, a window, 3D object, and/or 2D object), with a subject (e.g., 408 as described with respect to FIGS. 4A-4B and/or 710 as described with respect to FIGS. 7A-7F) (e.g., a person, user, another computer system, and/or the computer system), wherein the second object is separate from the first object and the subject, and wherein the first object is separate from the subject. In some embodiments, the instruction to align the first object, anchored to the second object, with the subject occurs when the application is first booted up. In some embodiments, the instruction to align the first object, anchored to the second object, with the subject occurs after a mode of operation is selected for the application by a user. In some embodiments, the application is of (e.g., installed on and/or executing by) the computer system. In some embodiments, the subject is separate from the computer system. In some embodiments, the subject is the computer system. In some embodiments, the first object and/or the second subject is separate from the computer system. In some embodiments, the first object and/or the second object is provided by the application.

After (and/or in conjunction with) receiving the instruction to align the first object, anchored to the second object, with the subject, the system process detects (504), via the one or more input devices, a current location (e.g., position, orientation, rotation, alignment, and/or angular position) of the subject (e.g., as described above with respect to FIGS. 4A-4B and 7A-7F). In some embodiments, the system process receives the current location of the subject from another system process and/or another application.

After (and/or in response to) detecting the current location of the subject, the system process renders (e.g., displays, generates a view of, projects, draws, outputs, and/or rasterizes) (506) the first object (508) (e.g., based on the current location (e.g., position, orientation, rotation, alignment, and/or angular position) of the subject and a current location (e.g., position, orientation, rotation, alignment, and/or angular position) of the second object) (e.g., as described above with respect to FIGS. 4A and/or 7B ). In some embodiments, rendering the first object includes displaying, via one or more display generation components (e.g., in communication with and/or included in the computer system), the first object. In some embodiments, the instruction to align the first object, anchored to the second object, with the subject includes aligning text and/or an image included with the first object so that the text and/or the image faces the subject, even as the orientation of the second object relative to the subject changes. In some embodiments, the first object is rendered based on a current location (e.g., position, orientation, rotation, alignment, and/or angular position) of the second object. In some embodiments, the first object is not rendered based on the current location of the subject. In some embodiments, the first object is placed in a virtual environment based on the current location of the subject and the current location the second object.

After (and/or in response to) detecting the current location of the subject, the system process renders (e.g., displays, generates a view of, projects, draws, outputs, and/or rasterizes) (506) the second object (510) based on the current location (e.g., position, orientation, rotation, alignment, and/or angular position) of the subject (e.g., as described above with respect to FIGS. 4A and/or 7B ).

After rendering the first object and the second object, the system process detects (512), via the one or more input devices, a change in the current location of the subject (e.g., as described above with respect to FIGS. 4B and/or 7C ). In some embodiments, the system process receives the change in the current location of the subject from another system process and/or another application.

In response to detecting the change in the current location of the subject, the system process re-renders (514) (e.g., updates, re-displays, re-generates a view of, re-projects, re-draws, re-outputs, and/or re-rasterizes), based on the change in the current location of the subject, the second object while maintaining an orientation of the first object with respect to the subject (e.g., as described above with respect to FIGS. 4B and/or 7C ). In some embodiments, maintaining the orientation of the first object with respect to the subject includes re-rendering the first object, such as based on the change in the current location of the subject and/or a current location of the second object. In some embodiments, maintaining the orientation of the first object with respect to the subject does not include re-rendering the first object.

In some embodiments, the first object is at a first position (e.g., a location and/or an orientation) within a virtual environment (e.g., 400, 404, 700, and/or 708) (e.g., a 3D environment, a virtual space, a scene, a simulation space, an augmented environment, and/or a mixed-reality space) while rendering the first object. In some embodiments, the second object is at a second position within the virtual environment while rendering the second object. In some embodiments, the second position is different from the first position. In some embodiments, the first object is at a third position within the virtual environment while re-rendering the second object. In some embodiments, the third position is different from the first position and the second position. In some embodiments, the second object is at the second position within the virtual environment while re-rendering the second object (e.g., a position of the second object within the virtual environment is maintained while a position of the first object within the virtual environment is changed as a result of the change in the current location of the subject). In some embodiments, while the first object is at the third position within the virtual environment, the first object has the same appearance when rendered as when the first object is at the first position. In some embodiments, while the second object is at the second position within the virtual environment while rendered the second object, the second object has a different appearance when re-rendered even though the second object does not change position within the virtual environment (e.g., perspective causes the different appearance rather than movement within the virtual environment).

In some embodiments, the second object is a 3D object (e.g., as described above with respect to FIGS. 4A-4B and/or 7A-7F) (e.g., a 3D model, a 3D entity, a 3D asset, and/or a 3D volume).

In some embodiments, the first object is a 3D object (e.g., as described above with respect to FIGS. 4A-4B and/or 7A-7F) (e.g., a 3D model, a 3D shape, a 3D entity, a 3D asset, and/or a 3D volume).

In some embodiments, the first object is a 2D object (e.g., as described above with respect to FIGS. 4A-4B and/or 7A-7F) (e.g., a scalable 2D object, a pixel-based 2D object, a 2D shape, a flat object, and/or a two-dimensional graphic).

In some embodiments, the first object inherits one or more visual attributes (e.g., an attribute relating to and/or affecting appearance, an anchor point, an offset, an alignment, a facing direction, a viewing angle, a scaling factor, a size, bounding box dimensions, animation settings, interactive behavior settings, a color scheme, a motion path, a visibility state and/or layout constraints) from (and/or of) the second object (e.g., as described above with respect to FIGS. 4A-4B and/or 7A-7B). In some embodiments, the application provides (and/or defines) one or more attributes of the first object and/or one or more attributes of the second object. In some embodiments, one or more attributed of the first object are not explicitly defined within a definition of the first object and instead are explicitly defined within a definition of the second object and inherited by (e.g., through an implicit definition) by the first object. In some embodiments, the system process provides (and/or defines) one or more attributes of the first object and/or one or more attributes of the second object. In some embodiments, another system process, different from the system process, provides (and/or defines) one or more attributes of the first object and/or one or more attributes of the second object. In some embodiments, the first object inherits the one or more visual attributes from the second object by a definition of the first object including a reference to the second object, the reference used to define one or more properties and/or one or more behaviors of the first object based on one or more properties and/or one or more behaviors of the second object.

In some embodiments, after (and/or in response to) detecting the current location of the subject, the system process places, at a first position (e.g., a location and/or an orientation) within a 3D environment (e.g., 400, 404, 700, and/or 708), the first object, wherein the first object is rendered based on the first object being placed at the first position within the 3D environment (e.g., as described above with respect to FIGS. 4A-4B and/or 7B-7E). In some embodiments, after (and/or in response to) detecting the current location of the subject, the system process places, at a second position within the 3D environment, the second object, wherein the second object is rendered based on the second object being placed at the second position within the 3D environment, and wherein the second position is different from the first position. In some embodiments, in response to detecting the change in the current location of the subject, the system process places, at a third position within the 3D environment, the first object, wherein the first object is re-rendered, in response to detecting the change in the current location of the subject, based on the first object being placed at the third position within the 3D environment, and wherein the third position is different from the first position and the second position. In some embodiments, in response to detecting the change in the current location of the subject, the system process maintains placement of, at the second position within the 3D environment, the second object, wherein the second object is re-rendered based on the second object being at the second position within the 3D environment. In some embodiments, rendering the first object and the second object includes computing a first position value (e.g., location and/or orientation) for the first object within the 3D virtual environment and a second position value (e.g., location and/or orientation) for the second object within the 3D virtual environment. In some embodiments, re-rendering the second object while maintaining the orientation of the first object with respect to the subject includes computing a third position value (e.g., including same location but different orientation than before) for the first object within the 3D virtual environment and a fourth position value (e.g., including different location and different orientation than before) for the second object within the 3D virtual environment. In some embodiments, the first position value for the first object and the second position value for the second object are used to render and/or display the first object and the second object. In some embodiments, the third position value for the first object and the fourth position value for the second object are used to render and/or display the first object and the second object.

In some embodiments, the subject is the computer system. In some embodiments, the current location of the subject is a position within a virtual environment (e.g., 400, 404, 700, and/or 708) (e.g., a 3D environment, a virtual space, a scene, a simulation space, an augmented environment, and/or a mixed-reality space). In some embodiments, the computer system detects the current location of the computer system by analyzing a position of the computer system and/or a change of a position of the computer system. In some embodiments, the computer system detects the current location of the computer system by analyzing a position of the computer system relative to the first object, second object, other objects and/or other 3D objects that are rendered by the computer system. In some embodiments, the virtual environment is a 3D environment. In some embodiments, the virtual environment is a 2D environment.

In some embodiments, the first object and the second object are provided by (e.g., originate from, obtained from, received from, and/or accessed from) the same application (e.g., as described above with respect to FIGS. 4A-4B and/or 7A-7F) (e.g., provided to the system process as one or more definitions before or in conjunction with (e.g., while, after, or as part of) receiving the instruction to align the first object with the subject). In some embodiments, the application creates, manages, and/or provides the first object and the second object. In some embodiments, the system process receives rendering instructions, vertices, meshes, texture information, position information, orientation information, and/or scale information about the first object and the second object. In some embodiments, the first object and the second object are rendered in the same scene.

In some embodiments, re-rendering the second object while maintaining the orientation of the first object with respect to the subject includes aligning a primary (e.g., main, principal major, reference, and/or control) axis of the first object with the current location of the subject without aligning a secondary (e.g., minor, auxiliary, and/or supplementary) axis of the first object with the current location of the subject (e.g., as described above with respect to FIGS. 4A-4B). In some embodiments, the primary axis of the first object is different from the secondary axis of the first object.

In some embodiments, the primary axis of the first object is defined by the application (e.g., as described above with respect to FIGS. 4A-4B). In some embodiments, the instruction to align the first object with the subject includes an instruction to align the primary axis of the first object with the current location of the first subject without aligning the secondary axis of the first subject with the current location of the subject.

In some embodiments, re-rendering the second object while maintaining the orientation of the first object with respect to the subject includes aligning a primary (e.g., main, principal major, reference, and/or control) axis of the first object and a secondary (e.g., minor, auxiliary, and/or supplementary) axis of the first object with the current location of the subject (e.g., as described above with respect to FIGS. 4A-4B). In some embodiments, the primary axis of the first object is different from the secondary axis of the first object.

In some embodiments, after re-rendering the second object while maintaining an orientation of the first object with respect to the subject, the system process detects, via the one or more input devices, another change in the current location of the subject, wherein the other change is different from the change. In some embodiments, in response to detecting the other change in the current location of the subject, in accordance with a determination that the first object would be rotated (e.g., within a virtual environment) more than a rotation limit to align with the subject, the system process re-renders the first object by rotating (e.g., within the virtual environment) the first object up to the rotation limit (e.g., as described above with respect to FIGS. 4A-4B). In some embodiments, in response to detecting the other change in the current location of the subject, in accordance with a determination that the first object would be rotated (e.g., within the virtual environment) less than the rotation limit to align with the subject, the system process re-renders (e.g., updates, re-displays, re-generates a view of, re-projects, re-draws, re-outputs, and/or re-rasterizes), based on the other change in the current location of the subject, the second object while maintaining an orientation of the first object with respect to the subject (e.g., as described above with respect to FIGS. 4A-4B).

In some embodiments, after re-rendering the second object while maintaining an orientation of the first object with respect to the subject, the system process detects, via the one or more input devices, another change in the current location of the subject, wherein the other change is different from the change. In some embodiments, in response to detecting the other change in the current location of the subject, in accordance with a determination that a change of size of the first object would exceed a threshold (e.g., a minimum or a maximum threshold), the system process ceases display of the first object (e.g., while re-rendering, based on the other change in the current location of the subject, the second object) (e.g., as described above with respect to FIGS. 4A-4B and/or 7E-7F). In some embodiments, in response to detecting the other change in the current location of the subject, in accordance with a determination that the change of size of the first object would not exceed the threshold, the system process re-renders (e.g., updates, re-displays, re-generates a view of, re-projects, re-draws, re-outputs, and/or re-rasterizes), based on the other change in the current location of the subject, the second object while maintaining an orientation of the first object with respect to the subject (e.g., as described above with respect to FIGS. 4A-4B and/or 7E-7F).

In some embodiments, the change in the current location is detected in response to detecting, via the one or more input device, a user input (e.g., as described above with respect to FIG. 4B) (e.g., a gesture and/or a gaze). In some embodiments, the user input is a gesture toward content displayed by the computer system.

In some embodiments, the application is not provided the current location of the subject (e.g., as described above with respect to FIGS. 4A-4B).

In some embodiments, re-rendering the second object while maintaining the orientation of the first object with respect to the subject occurs without receiving new (and/or updated) instructions from the application since receiving the instruction to align the first object, anchored to the second object, with the subject (e.g., as described above with respect to FIGS. 4A-4B).

Note that details of the processes described above with respect to process 500 (e.g., FIG. 5) are also applicable in an analogous manner to other processes described herein. For example, process 600 optionally includes one or more of the characteristics of the various processes described above with reference to process 500. For example, the aligning of process 500 can occur in response to the request of process 600. For brevity, these details are not repeated herein.

FIG. 6 is a flow diagram illustrating a process (e.g., process 600) for requesting alignment of content based on user location in accordance with some embodiments. Some operations in process 600 are, optionally, combined, the orders of some operations are, optionally, changed, and some operations are, optionally, omitted.

As described below, process 600 provides an intuitive way for requesting alignment of content based on user location in accordance with some embodiments. Process 600 reduces the cognitive burden on a user, thereby creating a more efficient human-machine interface. For battery-operated computing devices, enabling a user to interact with such devices faster and more efficiently conserves power and increases the time between battery charges.

In some embodiments, process 600 is performed at a computer system (e.g., 300), by an application (e.g., 330 and/or 340) (e.g., a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application), that is in communication with (and/or includes) one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) (e.g., as described above with respect to FIG. 3) and one or more display generation components (e.g., as described above with respect to FIG. 3) (e.g., a display screen, a projector, a head mounted display, and/or a touch-sensitive display). In some embodiments, the computer system is a head-mounted display (HMD) device, a communal device, a watch, a phone, a tablet, a fitness tracking device, a processor, a media device, a speaker, a television, an electronic device, and/or a personal computing device. In some embodiments, the application is installed on and/or executing by the computer system.

The application detects (602), via the one or more input devices, an input (e.g., voice command and/or gaze) (e.g., “can you give some fun facts about the moon?” as described above with respect to FIG. 7A) corresponding to (e.g., related to and/or corresponding to) a request to display content (e.g., 402, 402a, 402b, 402c, and/or 706) of the application (e.g., as described above with respect to FIGS. 4A-4B). In some embodiments, the input corresponding to the request to display the content of the application is directed to a user interface element, an object, and/or control displayed via the one or more display generation components.

In response to detecting the input corresponding to the request to display the content of the application, the application sends (604), to a system process (e.g., 310), a request (and/or command) to render (e.g., display, generate a view of, project, draw, output, and/or rasterize) a first object (e.g., 402b, 402c, and/or 706) (e.g., a popup, a menu, a virtual button, an icon, a widget, a control, a window, 3D object, and/or 2D object), anchored to (e.g., parent of, child of, grandparent of, grandchild of, attached to, spatially bound to, positionally liked to, synchronized with, tracked with, follows, related to, and/or co-located with) a second object (e.g., 402aand/or 704) (e.g., subset of content, a virtual button, an icon, a widget, a control, a window, 3D object, and/or 2D object) to be aligned (e.g., orient, intersect coordinates with, geometrically align, face, and/or share the same axis as) with a current location (e.g., position, orientation, rotation, alignment, and/or angular position) of a subject (e.g., as described with respect to 408 and/or 710) (e.g., a person, user, another computer system, and/or the computer system), wherein the second object is separate from the first object and the subject, and wherein the first object is separate from the subject. In some embodiments, the system process is part of and/or executing on behalf of an operating system of the computer system. In some embodiments, the content includes the first object and/or the second object. In some embodiments, the subject is separate from the computer system. In some embodiments, the subject is the computer system. In some embodiments, the first object and/or the second subject is separate from the computer system. In some embodiments, the first object and/or the second object is provided by the application. In some embodiments, the request to display the content of the application is a request display the first object and/or the second object. In some embodiments, the input corresponding to the request to display the content of the application is detected while the second object is displayed.

After sending the request to render the first object, anchored to the second object, to be aligned with the current location of the subject, the application receives (606), from the system process, an indication (e.g., a notification, a signal, an alert, a status update, a callback, a system event, an event trigger, an input acknowledgement and/or a data packet) of an input (e.g., a voice command and/or a gesture) directed to the content from the subject without the application receiving an indication (e.g., a notification, a signal, an alert, a status update, a callback, a system event, an event trigger, an input acknowledgement and/or a data packet) of the current location of the subject since sending the request (e.g., as described above with respect to FIGS. 4A-4B and/or 7A-7F).

In response to receiving the indication of the input directed to the content from the subject, the application resolves (608) (e.g., processes, settles, responds to, manages, resolves, and/or addresses) the input directed to the content (e.g., as described above with respect to FIGS. 4A-4B and/or 7A-7F). In some embodiments, resolving the input directed to the content includes performing an operation. In some embodiments, resolving the input directed to the content includes re-displaying and/or re-rendering at least a portion of the content.

In some embodiments, in response to detecting, via the one or more input devices, an input corresponding to a request to display the second object, the application sends, to the system process, a request to maintain an orientation of the second object within a virtual environment (e.g., 400, 404, 700, and/or 708) (e.g., while the current location of the subject changes). In some embodiments, sending, to the system process, the request to maintain the orientation of the second object within the virtual environment causes the second object to be re-rendered based on a change in the current location of the subject and/or a current location of the second object to ensure that the perspective of the virtual environment is maintained and allows the subject to change perspective of the second object by moving around the virtual environment. In some embodiments, the input corresponding to the request to display the second object is the input corresponding to the request to display the content of the application. In some embodiments, the input corresponding to the request to display the second object is different and/or separate from the input corresponding to the request to display the content of the application.

In some embodiments, the request to render the first object, anchored to the second object, to be aligned with the current location of the subject includes a request to align a primary axis (e.g., main, principal major, reference, and/or control) of the first object with the current location of the subject (e.g., as described above with respect to FIGS. 4A-4B). In some embodiments, the request to align the primary axis of the first object with the current location of the subject is separate from the request to render the first object, anchored to the second object, to be aligned with the current location of the subject.

In some embodiments, the request to align the primary axis of the first object with the current location of the subject includes a definition of the primary axis (e.g., as described above with respect to FIGS. 4A-4B). In some embodiments, the primary axis is defined by the application.

In some embodiments, the request to render the first object, anchored to the second object, to be aligned with the current location of the subject includes a request to align at least a primary (e.g., main, principal major, reference, and/or control) axis of the first object and a secondary (e.g., minor, auxiliary, and/or supplementary) axis of the first object with the current location of the subject. In some embodiments, the primary axis of the first object is different from the secondary axis of the first object (e.g., as described above with respect to FIGS. 4A-4B).

In some embodiments, the request to render the first object, anchored to the second object, to be aligned with the current location of the subject includes a request to align the first object with the current location of the subject within an angular limit (e.g., maximum and/or minimum angle) (e.g., as described above with respect to FIGS. 4A-4B). In some embodiments, the request to align the first object with the current location of the subject within the angular limit is separate from the request to render the first object, anchored to the second object, to be aligned with the current location of the subject.

In some embodiments, the second object is a 3D object (e.g., as described above with respect to FIGS. 4A-4B and/or 7A-7F) (e.g., a 3D model, a 3D shape, a 3D entity, a 3D asset, and/or a 3D volume).

In some embodiments, the first object is a 3D object (e.g., as described above with respect to FIGS. 4A-4B and/or 7A-7F) (e.g., a 3D model, a 3D shape, a 3D entity, a 3D asset, and/or a 3D volume).

In some embodiments, the first object is a 2D object (e.g., as described above with respect to FIGS. 4A-4B and/or 7A-7F (e.g., a scalable 2D object, a pixel-based 2D object, a 2D shape, a flat object, and/or a two-dimensional graphic).

In some embodiments, sending, to the system process, the request to render the first object, anchored to the second object to be aligned with the current location of the subject configures the system process to, place, at first position within a 3D environment, the first object, wherein the first object is rendered based on the first object being placed at the first position within the 3D environment (e.g., as described above with respect to FIGS. 4A-4B and/or 7A-7E). In some embodiments, sending, to the system process, the request to render the first object, anchored to the second object to be aligned with the current location of the subject configures the system process to, place, at a second position within the 3D environment, the second object, wherein the second object is rendered based on the second object being placed at the second position within the 3D environment, and wherein the second position is different from the first position (e.g., as described above with respect to FIGS. 4A-4B and/or 7A-7E).

In some embodiments, the subject is the computer system (e.g., as described above with respect to FIGS. 4A-4B and/or 7A-7E).

In some embodiments, before (e.g., after, while, and/or in conjunction with) sending, to the system process, the request to render the first object, anchored to the second object, to be aligned with the current location of the subject, the application sends, to the system process, a request to render the second object (e.g., as described above with respect to FIGS. 4A-4B and/or 7A-7B). In some embodiments, sending, to the system process, the request to render the second object includes sending a definition of (e.g., size, position, color, and/or characteristic) of the second object. ISE, before (e.g., after, while, and/or in conjunction with) sending, to the system process, the request to render the first object, anchored to the second object, to be aligned with the current location of the subject, the application sends, to the system process, a definition of the first object and/or the second object. In some embodiments, the request to render the first object, anchored to the second object, to be aligned with the current location of the subject includes a definition of the first object.

In some embodiments, resolving the input directed to the content includes changing the content (e.g., as described above with respect to FIGS. 4A-4B and/or 7A-7F). In some embodiments, changing the content includes providing new content to the system process. In some embodiments, changing the content includes assigning which content is given rendering priority.

In some embodiments, resolving the input directed to the content includes performing an operation (e.g., adding a calendar event, sending a text message, starting a timer, and/or playing music) corresponding to (e.g., related to and/or corresponding to) the content (e.g., as described above with respect to FIGS. 4A-4B and/or 7A-7F). In some embodiments, resolving the input directed to the content includes identifying the operation based on the input and/or the content.

In some embodiments, the request to render the first object, anchored to the second object, to be aligned with the current location of the subject includes a definition of the first object that enables the first object to inherit one or more attributes (e.g., as described above with respect to FIGS. 4A-4B and /or 7B) (e.g., an anchor point, an offset, an alignment, a facing direction, a viewing angle, a scaling factor, a size, bounding box dimensions, animation settings, interactive behavior settings, a color scheme, a motion path, a visibility state, and/or layout constraints) of the second object. In some embodiments, the system process un-anchors the first object to the second object in response to an input (e.g., gaze input, tap input, and/or another gesture). For example, the un-anchoring can occur when the input is directed to a region outside one or both of the first object and the second object.

Note that details of the processes described above with respect to process 600 (e.g., FIG. 6) are also applicable in an analogous manner to other processes described herein. For example, process 800 optionally includes one or more of the characteristics of the various processes described above with reference to process 600. For example, the request of process 500 can be rendered by process 800. For brevity, these details are not repeated herein.

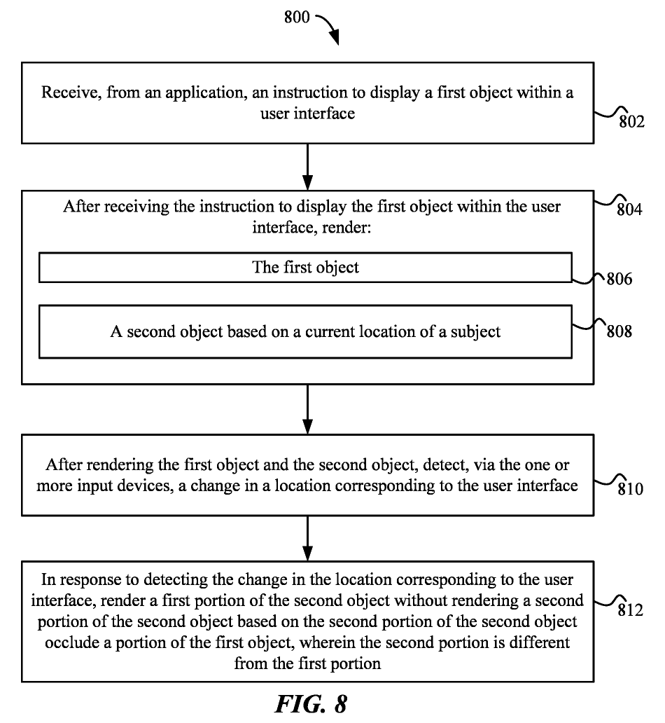

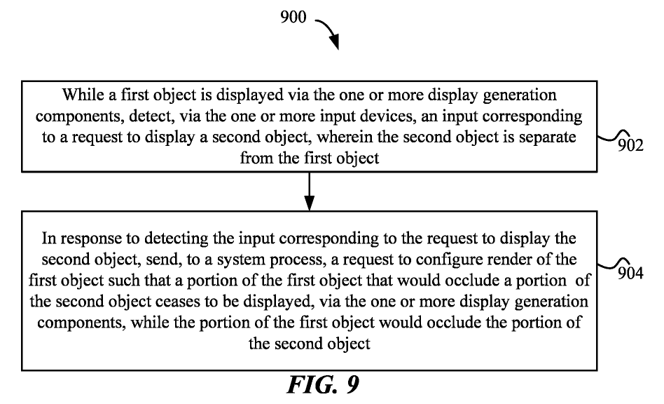

FIGS. 7A-7F illustrate an exemplary process for managing an overlay within an environment in accordance with some embodiments. The exemplary process is used to illustrate the processes described below, including the processes in FIGS. 8-9.

It should be recognized that FIGS. 7A-7F can use one or more of the same aspects discussed above. For example, 3D environment process 310 can receive a 3D object model from first user application 330 and render the 3D object model based on a current state of the environment and/or a user’s position to produce a 3D object to be displayed by display process 320. In some embodiments, the 3D object model also includes a definition of how a virtual object moves through a virtual environment. For example, the 3D object model can describe a path or orbit of a second virtual object (e.g., moon) around a third virtual object (e.g., earth), with a first virtual object (e.g., a text overlay) anchored to the second virtual object, such that from the user’s viewpoint, the first virtual object appears to follow the second virtual object along the path or orbit. In some embodiments, 3D environment process 310 renders the first virtual object so that the first virtual object overlays differently (e.g., breaks through and/or blocks) with respect to the third virtual object at different points along a path of the first virtual object through the virtual environment. Rendering the first virtual object and the third virtual object in this manner can provide the user with the perception that the first virtual object appears in front of or partially in front of the third virtual object (and/or the perception that the third virtual object is behind or partially behind the first virtual object). The ability for 3D environment process 310 to render virtual objects in this manner can allow for a better experience for the user. In some embodiments, different applications can provide definitions for different virtual objects that are rendered together by 3D environment process 310.

FIGS. 7A-7F illustrates environment 700 with a 3D astronomy application including multiple virtual objects (e.g., earth 702, moon 704, and text overlay 706). In some embodiments, environment 700 is a physical and/or virtual environment. For example, environment 700 can be a representation of a physical environment captured by one or more cameras of computer system 300. For another example, environment 700 can be a physical environment viewed through one or more at least partially translucent materials. It should be understood that environment 700 can be seen through a display or a display area of a computer system, such as an HMD device and/or smart glasses. In some embodiments, the display area is a display generation component, such as a translucent display and/or a display screen. In some embodiments, environment 700 is a completely virtual environment that is rendered by computer system 300. In some embodiments, virtual objects are displayed within and/or in a manner to appear as if they are within environment 700.

The bottom-right side of FIGS. 7A-7G includes diagram 708. Diagram 708 is a visual aid representing locations of objects within a virtual environment corresponding to environment 700. Diagram 708 includes user representation 710, moon representation 712, and earth representation 714 to indicate a position of both objects within the virtual environment. Diagram 708 also illustrates a position that the user is facing relative to moon representation 712 and earth representation 714. It should be understood that 3D and 2D objects are used as examples and that other virtual objects can be used with techniques described herein, including a geometrical figure, a character, a symbol, a representation of an inanimate object, and/or a representation of an animate object.

At FIG. 7A, the user is positioned so that the user is facing a backwall (e.g., the backwall is a wall with windows) of environment 700. Prior to displaying the 3D objects, the user launched the 3D astronomy application and requested the 3D astronomy application to display a 3D orbital map of an orbit path of moon 704 around earth 702. In response to the user’s request, 3D environment process 310 received one or more 3D models corresponding to virtual objects from the 3D astronomy application. For example, the 3D astronomy application can send a 3D model for moon 704, earth 702, and/or information overlays (e.g., text overlay 706) to 3D environment process 310. In some embodiments, the 3D models include a definition of how each virtual object moves through the virtual environment and relative to other virtual objects. In some embodiments, a single 3D model is provided which includes each virtual object and informational overlay illustrated in FIGS. 7A-7G. As described earlier with respect to FIG. 3, 3D environment process 310 is provided positional information about the user’s position from sensors in communication with computer system 300. In some embodiments, the positional information of the user is not provided to the 3D astronomy application. After receiving the 3D models, 3D environment process 310 causes display process 320 to display the virtual objects based on environment 700 and/or the user’s position.

As illustrated in FIG. 7A, the virtual objects of the 3D astronomy application are rendered with a first viewing angle so that moon representation 712 and earth representation 714 appear as if the user is viewing the virtual objects from a first reference point based on the user’s position in the virtual environment. At FIG. 7A, computer system 300 detects the user providing a voice command “Can you give some fun facts about the moon?”. It should be recognized that a voice command is an example of an input the user can provide computer system 300 and that other inputs such as tap gestures at virtual objects and/or gaze gestures at virtual objects can be recognized by computer system 300.

As illustrated in FIG. 7B, in response to detecting the user’s voice command, 3D environment process 310 renders text overlay 706 which includes facts about the moon. As illustrated in FIG. 7B, text overlay 706 is rendered by 3D environment process 310 to be initially aligned with the user’s viewpoint. In some embodiments, text overlay 706 is displayed to always be aligned with the user’s viewpoint. In some embodiments, text overlay 706 is defined by the 3D astronomy application to move in conjunction with the orbital path of moon 704. For example, the orbital path of text overlay 706 defines how text overlay 706 should be rendered as text overlay 706 moves with respect to moon 704. In some embodiments, text overlay 706 is anchored to and/or spatially bound to moon 704. In some embodiments, text overlay 706 inherits one or more attributes of moon 704 and/or earth 702, such as scaling properties and/or orientation alignment values as described above with respect to FIGS. 4A-4B. As illustrated in FIGS. 7A-7B, earth 702 is rendered at the same size by 3D environment process 310 because the user’s distance from earth 702 remains unchanged between the two figures.

As illustrated in diagram 708, a position of moon 704 is moved along its orbit of earth 702 results in earth 702 blocking a portion of moon 704 from the user’s viewpoint. As a result of the positions of moon 704, earth 702, and the user within the virtual environment, 3D environment process 310 renders moon 704 and earth 702 so that a portion of moon 704 that is blocked by earth 702 is not rendered. In some embodiments, 3D environment process 310 utilizes a mesh of moon 704 and a mesh of earth 702 to determine which portions of the objects are visible from the user’s current position.

At some time between FIGS. 7B and 7C, the user moves from the position illustrated in FIG. 7B to the position illustrated in FIG. 7C. One or more sensors, such as a camera, that is in communication with computer system 300, captures a change in the user’s position. 3D environment process 310 is notified of the user’s change in position. In response to the notification, 3D environment process 310 renders (and/or re-renders) earth 702 so that the user is presented with a second viewing angle of earth 702 (e.g., user now views Europe and Africa) and moon 704. As illustrated in FIGS. 7A and 7C, earth 702, moon 704, and text overlay 706 appear the same size as in FIG. 7B due to the user’s distance from the virtual objects being the same. However, between diagram 708 of FIGS. 7C and 7B, text overlay representation 716 is smaller in FIG. 7C, due to the user being closer to text overlay representation 716 in FIG. 7C. Since the user is closer to the text overlay in FIG. 7C, text overlay (e.g., text representation 716) shrank in the virtual environment (e.g., diagram 708) though 3D environment process 310 renders text overlay 706 at the same size within environment 700 as compared to FIG. 7B. As illustrated in FIG. 7C, due to the movement path of moon 704, earth 702 is no longer blocking a portion of moon 704 and text overlay 706. As such, 3D environment process 310 renders the entirety of earth 702, moon 704, and text overlay 706. As described above with respect to FIGS. 4A-4B, text overlay 706 is presented so that text overlay 706 is still aligned with the user’s position. In some embodiments, 3D environment process 310 re-renders only virtual objects that are changed due to a user’s movement.

At FIG. 7D, the user moves away from earth 702, moon 704, and text overlay 706. As a result, earth 702 and moon 704 appear slightly smaller from the user’s position. That is, earth 702 and moon 704 retain their original size within the virtual environment (e.g., diagram 708), but 3D environment process 310 renders earth 702 and moon 704 to appear smaller within environment 700 to the user due to the user’s position. Between diagrams 708 of FIGS. 7B-7D, text overlay 706 is illustrated to be largest in FIG. 7B and smallest in FIG. 7C. Since the user is further from text overlay 706 in FIG. 7D than in FIG. 7C, the text overlay is a larger size within the virtual environment though 3D environment process 310 renders the text overlay at the same size in FIGS. 7C and 7D.

Diagram 708 of FIG. 7D illustrates that text overlay 706 is breaking through earth 702. As a result, 3D environment process 310 renders a portion of text overlay 706 and does not render a portion of earth 702 that overlaps with text overlay 706 to provide the perception that text overlay 706 is in front of earth 702. In some embodiments, 3D environment process 310 utilizes a mesh of text overlay and a mesh of earth 702 to determine which portions of the objects are visible from the user’s current position.

At FIG. 7E, the user moves further away from earth 702, moon 704, and text overlay 706. As illustrated in FIG. 7E, earth 702 and text overlay 706 appear smaller from the user’s position. At FIG. 7E, text overlay 706 has reached a point at which 3D environment process 310 will no longer increase the size of text overlay 706 within the virtual environment based on the definition for scaling provided by the 3D astronomy application or a restriction set by 3D environment process 310. As illustrated at FIG. 7E, text overlay 706 is rendered by 3D environment process 310 with a different opacity to show that moon 704 is currently behind earth 702 in an orbital path of moon 704.

Diagram 708 of FIG. 7E illustrates that the relative size of text overlay representation 716 and the moon representation 712 have stayed the same relative to each other. Even though the size of moon 704 and text overlay 706 appear smaller to the user. Additionally, diagram 708 shows that as a result of the orbital path of text overlay 706 and moon 704 both objects are now behind earth 702 as shown in diagram 708. In some embodiments, the 3D astronomy application defines that the text overlay 706 should always be viewed by the user even when text overlay 706 is positioned behind earth 702 due to text overlay’s 706 orbital path. As a result, 3D environment process 310 renders a portion of text overlay 706 to appear in front of earth 702. Likewise, 3D environment process 310 renders earth 702 and text overlay 706 and does not render moon 704 to provide the perception that text overlay 706 is in front of earth 702.

At FIG. 7F, the user moves even further away from earth 702 and moon 704. As illustrated in FIG. 7F, earth 702 and moon 704 appear smaller from the user’s position. At FIG. 7F, text overlay 706 is no longer rendered by 3D environment process 310 based on a definition provided by the 3D astronomy application regarding restrictions set on displaying text overlay 706 when the user is more than a predetermined distance away from text overlay 706 or restrictions set by the 3D environment process 310.

In some embodiments, when separate user interfaces from different application are displayed and determined to overlap, 3D environment process 310 utilizes the boundaries of each user interface to create a visual separation between them. In such embodiments, 3D environment process 310 might not render a portion of a user interface that is not currently active, the portion including more than the overlap so as to make it easier to view an active user interface. This can help users distinguish or identify each interface, rather than relying on a breakthrough effect.

FIG. 8 is a flow diagram illustrating a process (e.g., process 800) for rendering content in accordance with some embodiments. Some operations in process 800 are, optionally, combined, the orders of some operations are, optionally, changed, and some operations are, optionally, omitted.

As described below, process 800 provides an intuitive way for rendering content in accordance with some embodiments. Process 800 reduces the cognitive burden on a user, thereby creating a more efficient human-machine interface. For battery-operated computing devices, enabling a user to interact with such devices faster and more efficiently conserves power and increases the time between battery charges.

In some embodiments, process 800 is performed at a computer system (e.g., 300), by a system process (e.g., 310), that is in communication with (and/or includes) one or more input devices (e.g., as described above with respect to FIG. 3) (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, the computer system is a head-mounted display (HMD) device, a communal device, a watch, a phone, a tablet, a fitness tracking device, a processor, a media device, a speaker, a television, an electronic device, and/or a personal computing device. In some embodiments, the system process is part of and/or executing on behalf of an operating system of the computer system.

The system process receives (802), from an application (e.g., 330 and/or 340) (e.g., a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application), an instruction (e.g., as described above with respect to FIG. 4A and/or the user’s request in FIG. 7A) (e.g., an API request, an operation request, an execution instruction, a function call, a command, and/or a request) to display a first object (e.g., 402b, 402c, and/or 706) (e.g., a pop-over with text and/or graphics, a tag, a virtual button, an icon, a widget, a control, a window, 3D object, and/or 2D object) within a user interface (e.g., as described above with respect to FIGS. 4A and/or 7A) (e.g., a window, a lock screen, and/or a home screen). In some embodiments, the system process displays, via one or more display generation components (e.g., a display screen, a projector, a head mounted display, and/or a touch-sensitive display), the first object within the user interface. In some embodiments, the application is of (e.g., installed on and/or executing by) the computer system. In some embodiments, the subject is separate from the computer system. In some embodiments, the subject is the computer system. In some embodiments, the first object and/or the second subject is separate from the computer system.

After (and/or in response to) receiving the instruction to display the first object within the user interface, the system process renders (804) (e.g., displays, generates a view of, projects, draws, outputs, and/or rasterizes) the first object (806) (e.g., based on the current location (e.g., position, orientation, rotation, alignment, and/or angular position) of the subject). In some embodiments, rendering the first object includes displaying, via one or more display generation components (e.g., in communication with and/or included in the computer system), the first object.

After (and/or in response to) receiving the instruction to display the first object within the user interface, the system process renders (804) a second object (808) (e.g., 402, 402a, 702, and/or 704) (e.g., a virtual button, an icon, a widget, a control, a window, 3D object, and/or 2D object) based on a current location (e.g., position, orientation, rotation, alignment, and/or angular position) of a subject (e.g., as described with respect to 408 and/or 710) (e.g., a person, user, another computer system, and/or the computer system). In some embodiments, the first object is rendered based on a current location (e.g., position, orientation, rotation, alignment, and/or angular position) of the second object. In some embodiments, the first object is not rendered based on the current location of the subject. In some embodiments, the first object is placed in a virtual environment based on the current location of the subject and the current location the second object.

After rendering the first object and the second object, the system process detects (810), via the one or more input devices, a change in a location corresponding to (e.g., affecting, related to, and/or associated with) the user interface (e.g., as described above with respect to FIGS. 4B and/or 7C-7E). In some embodiments, the change in the location corresponding to the user interface is a change in a current location of the first object. In some embodiments, the change in the location corresponding to the user interface is a change in a current location of the second object. In some embodiments, the change in the location corresponding to the user interface is a change in the current location of the subject. In some embodiments, the change in the location corresponding to the user interface is a change in a current location of another object.

In response to detecting the change in the location corresponding to the user interface, the system process renders (812) a first portion (e.g., a section, a part, a segment, a region, an area, a subsection, and/or a zone) of the second object without rendering a second portion (e.g., a section, a part, a segment, a region, an area, a subsection, and/or a zone) of the second object based on the second portion of the second object occluding (e.g., blocking, obstructing, and/or overlapping) a portion (e.g., a section, a part, a segment, a region, an area, a subsection, and/or a zone) of the first object (e.g., as described above with respect to FIGS. 4B, 7D and/or 7E,), wherein the second portion is different from the first portion.

In some embodiments, detecting the change in the location corresponding to the user interface includes detecting, via the one or more input devices, a change in a location (e.g., position, orientation, rotation, alignment, and/or angular position) of the subject (e.g., as described above with respect to FIGS. 4A-4B and/or 7A-7E). In some embodiments, the change in the location of the subject is detected when the subject moves to a different location within an environment. In some embodiments, the change in the location of the subject is detected when the subject moves their viewing angle (e.g., tilting head) but remains in the same location. In some embodiments, the change in the location of the subject is detected when the subject provides a gesture to the one or more input devices.

In some embodiments, detecting the change in the location corresponding to the user interface includes detecting, via the one or more input devices, a change in a position (e.g., location, orientation, rotation, alignment, and/or angular position) of the first object (e.g., as described above with respect to FIGS. 4B and/or 7D-7E). In some embodiments, the change in the position of the first object is detected when the subject’s view of the first object is changed.

In some embodiments, detecting the change in the location corresponding to the user interface includes detecting, via the one or more input devices, a change in a position (e.g., location, orientation, rotation, alignment, and/or angular position) of the second object (e.g., as described above with respect to FIGS. 4A-4B and/or 7A-7E). In some embodiments, the change in the position of the second object is detected when the subject’s view of the second object is changed.

In some embodiments, the second portion of the second object is determined to occlude the portion of the first object based on a mesh (e.g., topology, geometry, a surface model, a wireframe model, and/or a polygon mesh) of (e.g., corresponding to, related to, defining, belonging to and/or associated with) the second object and a mesh (e.g., topology, geometry, a surface model, a wireframe model, and/or a polygon mesh) of (e.g., corresponding to, related to, defining, belonging to and/or associated with) the first object (e.g., as described above with respect to FIGS. 7A-7E). In some embodiments, a mesh is a structure that defines a shape of a 3D object using vertices, edges, and faces. In some embodiments, the second portion of the second object is determined to occlude the portion of the first object by identifying that one or more points of the mesh of the second object are in front of and/or closer to a direction of the subject than one or more points of the mesh of the first object.

In some embodiments, the change in the location corresponding to the user interface is a first change in the location corresponding to the user interface. In some embodiments, after rendering the first portion of the second object without rendering the second portion of the second object, the system process detects, via the one or more input devices, a second change in the location corresponding to (e.g., affecting, related to, and/or associated with) the user interface, wherein the first change in the location corresponding to the user interface is separate from the second change in the location corresponding to the user interface (e.g., as described above with respect to FIGS. 7A-7E). In some embodiments, the second change in the location corresponding to the user interface is a change in a current location of the first object. In some embodiments, the second change in the location corresponding to the user interface is a change in a current location of the second object. In some embodiments, the second change in the location corresponding to the user interface is a change in the current location of the subject. In some embodiments, the second change in the location corresponding to the user interface is a change in a current location of another object. In some embodiments, in response to detecting the second change in the location corresponding to the user interface, the system process renders the first object, the first portion of the second object, and the second portion of the second object based on the second object not occluding any portion (e.g., a section, a part, a segment, a region, an area, a subsection, and/or a zone) of the first object (e.g., as described above with respect to FIGS. 7A-7E). In some embodiments, rendering the first object includes rendering the entire first object.

In some embodiments, the change in the location corresponding to the user interface is a first change in the location corresponding to the user interface. In some embodiments, after rendering the first portion of the second object without rendering the second portion of the second object, the system process detects, via the one or more input devices, a third change in the location corresponding to (e.g., affecting, related to, and/or associated with) the user interface, wherein the first change in the location corresponding to the user interface is separate from the third change in the location corresponding to the user interface (e.g., as described above with respect to FIGS. 7A-7E). In some embodiments, the third change in the location corresponding to the user interface is a change in a current location of the first object. In some embodiments, the third change in the location corresponding to the user interface is a change in a current location of the second object. In some embodiments, the third change in the location corresponding to the user interface is a change in the current location of the subject. In some embodiments, the third change in the location corresponding to the user interface is a change in a current location of another object. In some embodiments, in response to detecting the third change in the location corresponding to the user interface, the system process renders the second portion of the second object without rendering the first portion of the second object based on the first portion of the second object occluding the portion of the first object (e.g., as described above with respect to FIGS. 7A-7E).

In some embodiments, in response to detecting the change in the location corresponding to the user interface, the system process renders a first portion (e.g., a section, a part, a segment, a region, an area, a subsection, and/or a zone) of a third object (e.g., 704) without rendering a second portion (e.g., a section, a part, a segment, a region, an area, a subsection, and/or a zone) of the third object based on the second portion of the third object occluding a portion of the first object, wherein the third object is different from the first object and the second object, and wherein the second portion of the third object is different from the first portion of the third object (e.g., as described above with respect to FIGS. 7A-7E).

In some embodiments, the change in the location corresponding to the user interface is a first change in the location corresponding to the user interface. In some embodiments, after rendering the first portion of the second object without rendering the second portion of the second object and while the first object is displayed in a first size, the system process detects, via the one or more input devices, a location (e.g., within a virtual environment or a physical environment) of the subject (e.g., the computer system or a user using the computer system), wherein the subject is separate from the first object and the second object. In some embodiments, in response to detecting the location of the subject, in accordance with a determination that the location is a first distance from the first object, the system process renders (and/or displays), at a second size, the first object (e.g., including text, graphic, and/or image within the first object), wherein the second size is different from (e.g., greater or smaller than) the first size (e.g., as described above with respect to FIGS. 7D-7E). In some embodiments, in response to detecting the location of the subject, in accordance with a determination that the location is a second distance from the first object, the system process forgoes rendering (and/or display) of, at the second size, the first object, wherein the second distance is different from (e.g., greater or less than) the first distance (e.g., as described above with respect to FIG. 7F).

In some embodiments, in response to detecting the location of the subject and in accordance with the determination that the location is the second distance from the first object, the system process ceases display of the first object (e.g., as described above with respect to FIG. 7F).

In some embodiments, the first object and the second object are provided by (e.g., originate from, obtained from, received from, and/or accessed from) the same application (e.g., as described above with respect to FIGS. 7A-7E). In some embodiments, the first object and the second object are rendered in the same scene.

In some embodiments, while the first object is displayed within the user interface (and/or while the user interface is an active user interface), in accordance with a determination that another user interface would occlude a portion of the user interface, the system process renders a first portion (e.g., a section, a part, a segment, a region, an area, a subsection, and/or a zone) of the other user interface without rendering a second portion (e.g., a section, a part, a segment, a region, an area, a subsection, and/or a zone) of the other user interface irrespective of whether one or more user interface elements within the other user interface would occlude a portion (e.g., a section, a part, a segment, a region, an area, a subsection, and/or a zone) of the user interface, wherein the second portion of the other user interface is different from the first portion of the other user interface (e.g., as described above with respect to FIGS. 7A-7E). In some embodiments, the determination that the other user interface would occlude a portion of the user interface is irrespective of whether one or more user interface elements within the other user interface would occlude a portion (e.g., a section, a part, a segment, a region, an area, a subsection, and/or a zone) of the user interface. In some embodiments, the determination that the other user interface would occlude a portion of the user interface is not based on a mesh of a user interface element within the other user interface and/or the user interface. In some embodiments, while the first object is displayed within the user interface, in accordance with a determination that the other user interface would not occlude a portion of the user interface, the system process renders the first portion (e.g., a section, a part, a segment, a region, an area, a subsection, and/or a zone) of the other user interface and the second portion (e.g., a section, a part, a segment, a region, an area, a subsection, and/or a zone) of the other user interface (e.g., as described above with respect to FIGS. 7A-7E).

In some embodiments, the instruction to display the first object within the user interface includes an instruction to anchor (e.g., attach to, link to, bound to, connect to, map to, and/or position relative to) the first object to a third object (e.g., a pop-over with text and/or graphics, a tag, a virtual button, an icon, a widget, a control, a window, 3D object, and/or 2D object) (e.g., 702 and/or 704). In some embodiments, the third object is different from the first object and the second object.

In some embodiments, the first object is a pop-up (e.g., an overlay, a temporary overlay, a dialog box, a prompt, and/or an alert) user interface element (e.g., as described above with respect to FIGS. 7A-7E).

In some embodiments, the first object is a 2D (e.g., flat and/or planar) object (e.g., as described above with respect to FIGS. 7A-7E). In some embodiments, the 2D object is a text box.

In some embodiments, the second object is a 3D (e.g., volumetric, spatial, and/or virtual) object (e.g., as described above with respect to FIGS. 7A-7E).

In some embodiments, the first object is anchored to (e.g., attached to, linked to, bound to, connected to, mapped to, and/or positioned relative to) the second object (e.g., as described above with respect to FIGS. 7A-7E).

In some embodiments, the user interface includes a 3D environment (e.g., 700 and/or 708) (e.g., three-dimensional space, virtual environment, spatial environment, digital space, and/or digital space).

Note that details of the processes described above with respect to process 800 (e.g., FIG. 8) are also applicable in an analogous manner to other processes described herein. For example, process 900 optionally includes one or more of the characteristics of the various processes described above with reference to process 800. For example, the rendering of process 800 can occur in response to the request of process 900. For brevity, these details are not repeated herein.

FIG. 9 is a flow diagram illustrating a process (e.g., process 900) for requesting content to be rendered in accordance with some embodiments. Some operations in process 900 are, optionally, combined, the orders of some operations are, optionally, changed, and some operations are, optionally, omitted.

As described below, process 900 provides an intuitive way for requesting content to be rendered in accordance with some embodiments. Process 900 reduces the cognitive burden on a user, thereby creating a more efficient human-machine interface. For battery-operated computing devices, enabling a user to interact with such devices faster and more efficiently conserves power and increases the time between battery charges.

In some embodiments, process 900 is performed at a computer system (e.g., 300), by an application (e.g., 330 and/or 340) (e.g., a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application), that is in communication with (and/or includes) one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) (e.g., as described above with respect to FIG. 3) and one or more display generation components (e.g., a display screen, a projector, a head mounted display, and/or a touch-sensitive display) (e.g., as described above with respect to FIG. 3). In some embodiments, the computer system is a head-mounted display (HMD) device, a communal device, a watch, a phone, a tablet, a fitness tracking device, a processor, a media device, a speaker, a television, an electronic device, and/or a personal computing device. In some embodiments, the application is installed on and/or executing by the computer system.

While a first object (e.g., 400, 402a, 702, and/or 704) (e.g., content, a virtual button, an icon, a widget, a control, a window, 3D object, and/or 2D object) is displayed via the one or more display generation components, the application detects (902), via the one or more input devices, an input (e.g., as described with respect FIGS. 4A and/or 7A) (e.g., a selection input, a voice command. and/or a gaze) corresponding to (e.g., related to and/or corresponding) a request to display a second object (e.g., 402b, 402c, and/or 706) (e.g., a popup, a menu, a virtual button, an icon, a widget, a control, a window, 3D object, and/or 2D object), wherein the second object is separate from the first object. In some embodiments, the input corresponding to the request to display the second object is directed to a user interface element, an object, and/or control displayed via the one or more display generation components.

In response to detecting the input corresponding to the request to display the second object, the application sends (904), to a system process (e.g., 310), a request to configure (e.g., set up, initialize, establish, assign parameters to program, and/or specify setting for) render (e.g., display, generate a view of, project, draw, output, and/or rasterize) of the first object such that a (and/or any) portion (e.g., a section, a part, a segment, a region, an area, a subsection, and/or a zone) of the first object that would occlude (e.g., block, obstruct, and/or overlap) a portion (e.g., a section, a part, a segment, a region, an area, a subsection, and/or a zone) of the second object ceases to be displayed, via the one or more display generation components, while the portion of the first object would occlude the portion of the second object (e.g., as described in FIGS. 4A-4B and/or 7D-7E). In some embodiments, the system process is part of and/or executing on behalf of an operating system of the computer system.

In some embodiments, the portion of the first object is determined to occlude the portion of the second object based on a mesh (e.g., topology, geometry, a surface model, a wireframe model, and/or a polygon mesh) corresponding to (e.g., related to, defining, belonging to, and/or associated with) the portion of the first object intersecting (e.g., overlaps, contacts, superimposes, shares a region, engage at a boundary, and/or intersect spatially) with a mesh (e.g., topology, geometry, a surface model, a wireframe model, and/or a polygon mesh) corresponding to (e.g., related to, defining, belonging to, and/or associated with) the portion of the second object (e.g., as described above with respect to FIGS. 7A-7F). In some embodiments, a mesh is a structure that defines a shape of a 3D object using vertices, edges, and/or faces.

In some embodiments, the first object and the second object are provided by (e.g., originate from, obtained from, received from, and/or accessed from) the application (e.g., as described above with respect to FIGS. 7A-7F). In some embodiments, the first object and the second object are rendered in the same scene.

In some embodiments, the first object is displayed within a first user interface (e.g., a window, a lock screen, and/or a home screen) (e.g., as described above with respect to 402 and/or FIGS. 7A-7F). In some embodiments, a third object is displayed within a second user interface different from the first user interface, wherein the third object is separate from the first object and the second object. In some embodiments, the first object and/or the second object is provided by a first application. In some embodiments, the third object is provided by the first application. In some embodiments, the third object is provided by a second application different from the first application. In some embodiments, while the first user interface is active (e.g., selected, most recently interacted with, and/or being looked at by a user), the first user interface is rendered without rendering a portion (e.g., a section, a part, a segment, a region, an area, a subsection, and/or a zone) of the second user interface in accordance with a determination that a portion of the first user interface is to be occluded (e.g., blocked, obstructed, and/or overlapped) by the second user interface (e.g., as described above with respect to FIGS. 7D-7E) (e.g., irrespective of user interface elements within the second user interface). In some embodiments, the determination that the portion of the first user interface is to be occluded by the second user interface is not based on a mesh of a user interface element within the first user interface and/or the second user interface. In some embodiments, the portion of the second user interface does not occlude a portion of the first user interface. In some embodiments, the portion of the second user interface is not rendered only when the second user interface is a particular type of user interface, such as when the second user interface is not a pop up or related to the first user interface. In some embodiments, the determination that the portion of the first user interface is to be occluded by the second user interface is based on a boundary of the first user interface and a boundary of the second user interface. In some embodiments, while the first user interface is active, the first user interface is rendered while rendering the portion of the second user interface in accordance with a determination that a portion of the first user interface is not to be occluded (e.g., blocked, obstructed, and/or overlapped) by the second user interface (e.g., irrespective of user interface elements within the second user interface). In some embodiments, while the second user interface is active, the second user interface is rendered without rendering a portion of the first user interface in accordance with a determination that a portion of the second user interface is to be occluded (e.g., blocked, obstructed, and/or overlapped) by the first user interface (e.g., irrespective of user interface elements within the second user interface). In some embodiments, while the second user interface is active, the second user interface is rendered while rendering a portion of the first user interface in accordance with a determination that a portion of the second user interface is to be occluded (e.g., blocked, obstructed, and/or overlapped) by the first user interface (e.g., irrespective of user interface elements within the second user interface).

In some embodiments, the first object and the second object are displayed within a 3D environment (e.g., 400, 404, 700, and/or 708) (e.g., three-dimensional space, virtual environment, spatial environment, digital space, and/or digital space) via the one or more display generation components.

In some embodiments, the first object is provided by (e.g., originate from, obtained from, received from, and/or accessed from) the application. In some embodiments, the second object is provided by (e.g., originate from, obtained from, received from, and/or accessed from) another application (e.g., 330 and/or 340) (e.g., a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application) different from the application.

In some embodiments, the first object is anchored to (e.g., attached to, linked to, bound to, connected to, mapped to, and/or positioned relative to) a third object (e.g., 704) (e.g., a pop-over with text and/or graphics, a tag, a virtual button, an icon, a widget, a control, a window, 3D object, and/or 2D object) different from the first object and the second object.

In some embodiments, the second object is a pop-up (e.g., an overlay, a temporary overlay, a dialog box, a prompt, and/or an alert) user interface element (e.g., as described above with respect to FIGS. 7A-7F).

In some embodiments, the first object is a 2D (e.g., flat and/or planar) object (e.g., as described above with respect to FIGS. 7A-7F). In some embodiments, the 2D object is a text box.

In some embodiments, the first object is a 3D (e.g., volumetric, spatial, and/or virtual) object (e.g., as described above with respect to FIGS. 7A-7F).

In some embodiments, the first object is anchored to (e.g., attached to, linked to, bound to, connected to, mapped to, and/or positioned relative to) the second object (e.g., as described above with respect to FIGS. 7A-7F).

Note that details of the processes described above with respect to process 900 (e.g., FIG. 9) are also applicable in an analogous manner to the processes described herein. For example, process 500 optionally includes one or more of the characteristics of the various processes described herein with reference to process 900. For example, the aligning of process 500 can occur with the request of process 900. For brevity, these details are not repeated herein.

FIG. 10A illustrates an electronic system 1000 with which some examples of the subject technology may be implemented. The electronic system 1000 can be, and/or can be a part of, the electronic device 105, the handheld electronic device 104, the electronic device 110, the electronic device 115, and/or the server 120 as shown in FIG. 1. The electronic system 1000 may include various types of computer readable media and interfaces for various other types of computer readable media. The electronic system 1000 includes a bus 1008, one or more processing unit(s) 1012, a system memory 1004 (and/or buffer), a ROM 1010, a permanent storage device 1002, an input device interface 1014, an output device interface 1006, and one or more network interfaces 1016, or subsets and variations thereof.

The bus 1008 collectively represents all system, peripheral, and chipset buses that communicatively connect the numerous internal devices of the electronic system 1000. In some examples, the bus 1008 communicatively connects the one or more processing unit(s) 1012 with the ROM 1010, the system memory 1004, and the permanent storage device 1002. From these various memory units, the one or more processing unit(s) 1012 retrieves instructions to execute and data to process in order to execute the processes of the subject disclosure. The one or more processing unit(s) 1012 can be a single processor or a multi-core processor in different examples.

The ROM 1010 stores static data and instructions that are needed by the one or more processing unit(s) 1012 and other modules of the electronic system 1000. The permanent storage device 1002, on the other hand, may be a read-and-write memory device. The permanent storage device 1002 may be a non-volatile memory unit that stores instructions and data even when the electronic system 1000 is off. In some examples, a mass-storage device (such as a magnetic or optical disk and its corresponding disk drive) may be used as the permanent storage device 1002.

In some examples, a removable storage device (such as a floppy disk, flash drive, and its corresponding disk drive) may be used as the permanent storage device 1002. Like the permanent storage device 1002, the system memory 1004 may be a read-and-write memory device. However, unlike the permanent storage device 1002, the system memory 1004 may be a volatile read-and-write memory, such as random access memory. The system memory 1004 may store any of the instructions and data that one or more processing unit(s) 1012 may need at runtime. In some examples, the processes of the subject disclosure are stored in the system memory 1004, the permanent storage device 1002, and/or the ROM 1010 (which are each implemented as a non-transitory computer-readable medium). From these various memory units, the one or more processing unit(s) 1012 retrieves instructions to execute and data to process in order to execute the processes of some examples.

The bus 1008 also connects to the input and output device interfaces 1014 and 1006. The input device interface 1014 enables a user to communicate information and select commands to the electronic system 1000. Input devices that may be used with the input device interface 1014 may include, for example, alphanumeric keyboards and pointing devices (also called “cursor control devices”). The output device interface 1006 may enable, for example, the display of images generated by electronic system 1000. Output devices that may be used with the output device interface 1006 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. Some examples may include devices that function as both input and output devices, such as a touchscreen. In these examples, feedback provided to the user can be any form of sensory feedback, such as visual feedback, auditory feedback, or tactile feedback; and input from the user can be received in any form, including acoustic, speech, or tactile input.

Finally, as shown in FIG. 10A, the bus 1008 also couples the electronic system 1000 to one or more networks and/or to one or more network nodes, such as the electronic device 110 shown in FIG. 1, through the one or more network interface(s) 1016. In this manner, the electronic system 1000 can be a part of a network of computers (such as a LAN, a wide area network (“WAN”), or an Intranet, or a network of networks, such as the Internet. Any or all components of the electronic system 1000 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some examples include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some examples are performed by one or more integrated circuits, such as application specific integrated circuits (ASICs) or field programmable gate arrays (FPGAs). In some examples, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, some examples of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user’s client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an example of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Some examples within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some examples, the tangible computer-readable storage medium can be directly coupled to a computing device, while in other examples, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, some examples are performed by one or more integrated circuits, such as ASICs or FPGAs. In some examples, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In some examples, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In some examples, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more examples, some examples, other examples, such examples, one example, for example, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other examples. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure. Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules and/or components.

Implementations within the scope of the present disclosure include a computer-readable storage medium that encodes instructions organized as an application (e.g., application 1028) that, when executed by one or more processing units, control an electronic device (e.g., device 1026) to perform the method of FIG. 10B, the method of FIG. 10C, and/or one or more other processes and/or methods described herein.

It should be recognized that application 1028 (shown in FIG. 10D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 1028 is an application that is pre-installed on device 1026 at purchase (e.g., a first party application). In other embodiments, application 1028 is an application that is provided to device 1026 via an operating system update file (e.g., a first party application or a second party application). In some embodiments, application 1028 is an application that is provided via an application store. In some embodiments, the application store can be an application store that is pre-installed on device 1026 at purchase (e.g., a first party application store). In some embodiments, the application store is a third-party application store (e.g., an application store that is provided by another application store, downloaded via a network, and/or read from a storage device).

Referring to FIGS. 10B and 7F, application 1028 obtains information (e.g., 1018). In some embodiments, at 1018, information is obtained from at least one hardware component of the device 1026. In some embodiments, at 1018, information is obtained from at least one software module (e.g., set of instructions) of the device 1026. In some embodiments, at 1018, information is obtained from at least one hardware component external to the device 1026 (e.g., a peripheral device, an accessory device, and/or a server). In some embodiments, the information obtained at 1018 includes positional information, time information, notification information, user information, environment information, electronic device state information, weather information, media information, historical information, event information, hardware information, and/or motion information. In some embodiments, in response to and/or after obtaining the information at 1018, application 1028 provides the information to a system (e.g., 1020).

In some embodiments, the system (e.g., 1038 shown in FIG. 10E) is an operating system hosted on the device 1026. In some embodiments, the system (e.g., 1038 shown in FIG. 10E) is an external device (e.g., a server, a peripheral device, an accessory, and/or a personal computing device) that includes an operating system.

Referring to FIGS. 10C and 10G, application 1028 obtains information (e.g., 1022). In some embodiments, the information obtained at 1022 includes positional information, time information, notification information, user information, environment information electronic device state information, weather information, media information, historical information, event information, hardware information and/or motion information. In response to and/or after obtaining the information at 1022, application 1028 performs an operation with the information (e.g., 1024). In some embodiments, the operation performed at 1024 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1038 based on the information.

In some embodiments, one or more steps of the method of FIG. 10B and/or the method of FIG. 10C is performed in response to a trigger. In some embodiments, the trigger includes detection of an event, a notification received from system 1038, a user input, and/or a response to a call to an API provided by system 1038.

In some embodiments, the instructions of application 1028, when executed, control device 1026 to perform the method of FIG. 10B and/or the method of FIG. 10C by calling an application programming interface (API) (e.g., API 1034) provided by system 1038. In some embodiments, application 1028 performs at least a portion of the method of FIG. 10B and/or the method of FIG. 10C without calling API 1034.

In some embodiments, one or more steps of the method of FIG. 10B and/or the method of FIG. 10C includes calling an API (e.g., API 1034) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 10D, device 1026 is illustrated. In some embodiments, device 1026 is a personal computing device, a smart phone, a smart watch, a fitness tracker, a head mounted display (HMD) device, a media device, a communal device, a speaker, a television, and/or a tablet. Device 1026 includes application 1028 and an operating system (not shown) (e.g., system 1038 shown in FIG. 10E). Application 1028 includes application implementation instructions 1030 and API calling instructions 1032. System 1038 includes API 1034 and implementation instructions $00. It should be recognized that device 1026, application 1028, and/or system 1038 can include more, fewer, and/or different components than illustrated in FIG. 10D and 10E.

In some embodiments, application implementation instructions 1030 is a software module that includes a set of one or more computer-readable instructions. In some embodiments, the set of one or more instructions of instructions 1030 correspond to one or more operations performed by application 1028. For example, when application 1028 is a messaging application, application implementation instructions 1030 can include operations to receive and send messages. In some embodiments, application implementation instructions 1030 communicates with API calling instructions to communicate with system 1038 via API 1034 (shown in FIG. 10E).

In some embodiments, API-calling instructions 1032 is a software module that includes a set of one or more computer-executable instructions.

In some embodiments, implementation instructions 1036 is a software module that includes a set of one or more computer-executable instructions.

In some embodiments, API 1034 is a software module that includes a set of one or more computer-executable instructions. In some embodiments, API 1034 provides an interface that allows a different set of instructions (e.g., API calling instructions 1032) to access and/or use one or more functions, methods, procedures, data structures, classes, and/or other services provided by implementation instructions 1036 of system 1038. For example, API-calling instructions 1032 can access a feature of implementation instructions 1036 through one or more API calls or invocations (e.g., embodied by a function or a method call) exposed by API 1034 and can pass data and/or control information using one or more parameters via the API calls or invocations. In some embodiments, API 1034 allows application1028 to use a service provided by a Software Development Kit (SDK) library. In some embodiments, application 1028 incorporates a call to a function or method provided by the SDK library and provided by API 1034 or uses data types or objects defined in the SDK library and provided by API 1034. In some embodiments, API-calling instructions 1032 makes an API call via API 1034 to access and use a feature of implementation instructions 1036 that is specified by API 1034. In such embodiments, implementation instructions 1036 can return a value via API 1034 to API-calling instructions 1032 in response to the API call. The value can report to application 1028 the capabilities or state of a hardware component of device 1026, including those related to aspects such as input capabilities and state, output capabilities and state, processing capability, power state, storage capacity and state, and/or communications capability. In some embodiments, API 1034 is implemented in part by firmware, microcode, or other low level logic that executes in part on the hardware component.

In some embodiments, API 1034 allows a developer of API-calling instructions 1032 (which can be a third-party developer) to leverage a feature provided by implementation instructions 1036. In such embodiments, there can be one or more set of API-calling instructions (e.g., including API-calling instructions 1032) that communicate with implementation instructions 1036. In some embodiments, API 1034 allows multiple sets of API-calling instructions written in different programming languages to communicate with implementation instructions 1036 (e.g., API 1034 can include features for translating calls and returns between implementation instructions 1036 and API-calling instructions 1032) while API 1034 is implemented in terms of a specific programming language. In some embodiments, API-calling instructions 1032 calls APIs from different providers such as a set of APIs from an OS provider, another set of APIs from a plug-in provider, and/or another set of APIs from another provider (e.g., the provider of a software library) or creator of the another set of APIs.

Examples of API 1034 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 1026. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 1036 is a system (e.g., operating system, server system) software module (e.g., a collection of computer-readable instructions) that is constructed to perform an operation in response to receiving an API call via API 1034. In some embodiments, implementation instructions 1036 is constructed to provide an API response (via API 1034) as a result of processing an API call. By way of example, implementation instructions 1036 and API-calling instructions 1032 can each be any one of an operating system, a library, a device driver, an API, an application program, or other module. It should be understood that implementation instructions 1036 and API-calling instructions 1032 can be the same or different type of software module from each other. In some embodiments, implementation instructions 1036 is embodied at least in part in firmware, microcode, or other hardware logic.

In some embodiments, implementation instructions 1036 returns a value through API 1034 in response to an API call from API-calling instructions 1032. While API 1034 defines the syntax and result of an API call (e.g., how to invoke the API call and what the API call does), API 1034 might not reveal how implementation instructions 1036 accomplishes the function specified by the API call. Various API calls are transferred via the one or more application programming interfaces between API-calling instructions 1032 and implementation instructions 1036. Transferring the API calls can include issuing, initiating, invoking, calling, receiving, returning, and/or responding to the function calls or messages. In other words, transferring can describe actions by either of API-calling instructions 1032 or implementation instructions 1036. In some embodiments, a function call or other invocation of API 1034 sends and/or receives one or more parameters through a parameter list or other structure.

In some embodiments, implementation instructions 1036 provides more than one API, each providing a different view of or with different aspects of functionality implemented by implementation instructions 1036. For example, one API of implementation instructions 1036 can provide a first set of functions and can be exposed to third party developers, and another API of implementation instructions 1036 can be hidden (e.g., not exposed) and provide a subset of the first set of functions and also provide another set of functions, such as testing or debugging functions which are not in the first set of functions. In some embodiments, implementation instructions 1036 calls one or more other components via an underlying API and thus be both a set of API calling instructions and a set of implementation instructions. It should be recognized that implementation instructions 1036 can include additional functions, methods, classes, data structures, and/or other features that are not specified through API 1034 and are not available to API calling instructions 1032. It should also be recognized that API calling instructions 1032 can be on the same system as implementation instructions 1036 or can be located remotely and access implementation instructions 1036 using API 1034 over a network. In some embodiments, implementation instructions 1036, API 1034, and/or API-calling instructions 1032 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, processes 500, 600, 800 and/or 900 (e.g., FIGS. 5, 6, 8, and/or 9) is performed at a first computer system (as described herein) via a system process (e.g., an operating system process, a server system process) that is different from one or more applications executing and/or installed on the first computer system.

In some embodiments, processes 500, 600, 800 and/or 900 (e.g., FIGS. 5, 6, 8, and/or 9) is performed at a first computer system (as described herein) by an application that is different from a system process. In some embodiments, the instructions of the application, when executed, control the first computer system to perform 500, 600, 800 and/or 900 (e.g., FIGS. 5, 6, 8, and/or 9) by calling an application programming interface (API) provided by the system process. In some embodiments, the application performs at least a portion of 500, 600, 800 and/or 900 (e.g., FIGS. 5, 6, 8, and/or 9)) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform 500, 600, 800 and/or 900 (e.g., FIGS. 5, 6, 8, and/or 9) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions.

As described above, in some embodiments, the application controls the first computer system to perform 500, 600, 800 and/or 900 (e.g., FIGS. 5, 6, 8, and/or 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., 1026) that runs the application. In some embodiments, the set of implementation instructions is included in an electronic device that is separate from the device that runs the application.

What is claimed is:

1. A method, comprising:
at a computer system, by a system process, that is in communication with one or more input devices:
receiving, from an application, an instruction to align a first object, anchored to a second object, with a subject, wherein the second object is separate from the first object and the subject, and wherein the first object is separate from the subject;
after receiving the instruction to align the first object, anchored to the second object, with the subject, detecting, via the one or more input devices, a current location of the subject;
after detecting the current location of the subject, rendering:
the first object; and
the second object based on the current location of the subject;
after rendering the first object and the second object, detecting, via the one or more input devices, a change in the current location of the subject; and
in response to detecting the change in the current location of the subject, re-rendering, based on the change in the current location of the subject, the second object while maintaining an orientation of the first object with respect to the subject.

2. The method of claim 1, wherein:
the first object is at a first position within a virtual environment while rendering the first object;
the second object is at a second position within the virtual environment while rendering the second object;
the second position is different from the first position;
the first object is at a third position within the virtual environment while re-rendering the second object;
the third position is different from the first position and the second position; and
the second object is at the second position within the virtual environment while re-rendering the second object.

3. The method of claim 1, wherein the second object is a 3D object.

4. The method of claim 3, wherein the first object is a 3D object.

5. The method of claim 3, wherein the first object is a 2D object.

6. The method of claim 1, wherein the first object inherits one or more visual attributes from the second object.

7. The method of claim 1, further comprising:
after detecting the current location of the subject, placing, at a first position within a 3D environment, the first object, wherein the first object is rendered based on the first object being placed at the first position within the 3D environment;
after detecting the current location of the subject, placing, at a second position within the 3D environment, the second object, wherein the second object is rendered based on the second object being placed at the second position within the 3D environment, and wherein the second position is different from the first position;
in response to detecting the change in the current location of the subject, placing, at a third position within the 3D environment, the first object, wherein the first object is re-rendered, in response to detecting the change in the current location of the subject, based on the first object being placed at the third position within the 3D environment, and wherein the third position is different from the first position and the second position; and
in response to detecting the change in the current location of the subject, maintaining placement of, at the second position within the 3D environment, the second object, wherein the second object is re-rendered based on the second object being at the second position within the 3D environment.

8. The method of claim 1, wherein the subject is the computer system, and wherein the current location of the subject is a position within a virtual environment.

9. The method of claim 1, wherein the first object and the second object are provided by the same application.

10. The method of claim 1, wherein re-rendering the second object while maintaining the orientation of the first object with respect to the subject includes aligning a primary axis of the first object with the current location of the subject without aligning a secondary axis of the first object with the current location of the subject, wherein the primary axis of the first object is different from the secondary axis of the first object.

11. The method of claim 10, wherein the primary axis of the first object is defined by the application.

12. The method of claim 1, wherein re-rendering the second object while maintaining the orientation of the first object with respect to the subject includes aligning a primary axis of the first object and a secondary axis of the first object with the current location of the subject, wherein the primary axis of the first object is different from the secondary axis of the first object.

13. The method of claim 1, further comprising:
after re-rendering the second object while maintaining an orientation of the first object with respect to the subject, detecting, via the one or more input devices, another change in the current location of the subject, wherein the other change is different from the change; and
in response to detecting the other change in the current location of the subject:
in accordance with a determination that the first object would be rotated more than a rotation limit to align with the subject, re-rendering the first object by rotating the first object up to the rotation limit; and
in accordance with a determination that the first object would be rotated less than the rotation limit to align with the subject, re-rendering, based on the other change in the current location of the subject, the second object while maintaining an orientation of the first object with respect to the subject.

14. The method of claim 1, further comprising:
after re-rendering the second object while maintaining an orientation of the first object with respect to the subject, detecting, via the one or more input devices, another change in the current location of the subject, wherein the other change is different from the change; and
in response to detecting the other change in the current location of the subject:
in accordance with a determination that a change of size of the first object would exceed a threshold, ceasing display of the first object; and
in accordance with a determination that the change of size of the first object would not exceed the threshold, re-rendering, based on the other change in the current location of the subject, the second object while maintaining an orientation of the first object with respect to the subject.

15. The method of claim 1, wherein the change in the current location is detected in response to detecting, via the one or more input device, a user input.

16. The method of claim 1, wherein the application is not provided the current location of the subject.

17. The method of claim 1, wherein re-rendering the second object while maintaining the orientation of the first object with respect to the subject occurs without receiving new instructions from the application since receiving the instruction to align the first object, anchored to the second object, with the subject.

18. A non-transitory computer-readable storage medium storing one or more programs configured to be executed by one or more processors of a computer system, by a system process, that is in communication with one or more input devices, the one or more programs including instructions for:
receiving, from an application, an instruction to align a first object, anchored to a second object, with a subject, wherein the second object is separate from the first object and the subject, and wherein the first object is separate from the subject;
after receiving the instruction to align the first object, anchored to the second object, with the subject, detecting, via the one or more input devices, a current location of the subject;
after detecting the current location of the subject, rendering:
the first object; and
the second object based on the current location of the subject;
after rendering the first object and the second object, detecting, via the one or more input devices, a change in the current location of the subject; and
in response to detecting the change in the current location of the subject, re-rendering, based on the change in the current location of the subject, the second object while maintaining an orientation of the first object with respect to the subject.

19. A computer system, by a system process, configured to communicate with one or more input devices, the computer system comprising:
one or more processors; and
memory storing one or more programs configured to be executed by the one or more processors, the one or more programs including instructions for:
receiving, from an application, an instruction to align a first object, anchored to a second object, with a subject, wherein the second object is separate from the first object and the subject, and wherein the first object is separate from the subject;
after receiving the instruction to align the first object, anchored to the second object, with the subject, detecting, via the one or more input devices, a current location of the subject;
after detecting the current location of the subject, rendering:
the first object; and
the second object based on the current location of the subject;
after rendering the first object and the second object, detecting, via the one or more input devices, a change in the current location of the subject; and
in response to detecting the change in the current location of the subject, re-rendering, based on the change in the current location of the subject, the second object while maintaining an orientation of the first object with respect to the subject.
